(19) United States
(12) Patent Application Publication
(10) Pub. No.: US 2008/0004202 A1
(43) Pub. Date: Jan. 3, 2008

(54) Method for the Production of Detergent or Cleaning Agents

(75) Inventors: Barthel Wolfgang, Langenfeld (DE); Salvatore Fileccia, Oberhausen (DE); Ulf Arno Timmann, Koln (DE); Thomas Holderbaum, Hilden (DE); Sandra Behr, Hilden (DE); Dirk Gerst, Dusseldorf (DE)

Correspondence Address: CONNOLLY BOVE LODGE & HUTZ LLP, PO BOX 2207, WILMINGTON, DE, 19899-2207, US

(73) Assignee: Henkel KGaA, Dusseldorf (DE)

(21) Appl. No.: 11/587,674

(22) PCT Filed: Apr. 21, 2005
(86) PCT No.: PCT/EP05/04260

§ 371 Date: Dec. 26, 2006

(30) Foreign Application Priority Data
Apr. 28, 2004 (DE) 10 2004 020 839.5

(51) Int. Cl. C11D 17/00; C11D 17/04

(52) U.S. Cl. 510/439

(57) ABSTRACT

Processes comprising: (a) providing a molding having a cavity, wherein the cavity has an opening on a surface of the molding; (b) applying a first film material over the opening of the cavity; (c) thermoforming the first film material into the cavity; and (d) introducing a substance selected from the group consisting of washing actives, cleaning actives and mixtures thereof into the cavity are described for the preparation of detergent/cleaning agent, and in particular, pre-dosed combination products containing solid and liquid phases.

The present invention lies in the field of washing or cleaning compositions. In particular, the present invention relates to a process for producing washing or cleaning compositions, especially dosage units of washing or cleaning compositions.

Washing or cleaning compositions are nowadays available to the consumer in various supply forms. In addition to washing powders and granules, this range also includes, for example, detergent concentrates in the form of extruded or tableted compositions. These solid, concentrated and compacted supply forms feature reduced volume per dosage unit and hence reduce the costs for packaging and transport. The washing or cleaning composition tablets in particular additionally satisfy the wish of the consumer for simple dosage. The corresponding compositions have been described comprehensively in the prior art. In addition to the advantages cited, compacted washing or cleaning compositions, however, also have a series of disadvantages. Tableted supply forms in particular, owing to their high compaction, frequently feature retarded decomposition and hence retarded release of their ingredients. To solve this “conflict” between sufficient tablet hardness and short decomposition times, the patent literature discloses numerous technical solutions, and reference shall be made at this point by way of example to the use of so-called tablet disintegrants. These disintegration accelerants are added to the tablets in addition to the washing- or cleaning-active substances, but themselves generally do not have any washing- or cleaning-active properties and in this way increase the complexity and the costs of these compositions. A further disadvantage of the tableting of active substance mixtures, especially washing- or cleaning-active substance-containing mixtures, is the inactivation of the active substances present as a result of the compacting pressure which occurs in the tableting. An inactivation of the active substances can also be effected by chemical reaction owing to the increased contact surfaces of the ingredients resulting from the tableting.

As an alternative to the above-described particulate or compacted washing or cleaning compositions, solid or liquid washing or cleaning compositions which have water-soluble or water-dispersible packaging have increasingly been described in the last few years. Like the tablets, these compositions feature simplified dosage, since they can be dosed together with the outer packaging into the washing machine or the machine dishwasher, and, on the other hand, they simultaneously also enable the formulation of liquid or pulverulent washing or cleaning compositions which feature better dissolution and more rapid activity compared to the compactates.

For example, EP 1 314 654 A2 (Unilever) discloses a dome-shaped pouch with a receiving chamber which comprises a liquid.

WO 01/83657 A2 (Procter & Gamble), in contrast, provides pouches which comprise two particulate solids, each of which are present in fixed regions and do not mix with one another, in a receiving chamber.

In addition to the packages which have only one receiving chamber, the prior art also discloses supply forms which comprise more than one receiving chamber or more than one formulation type.

The European application EP 1 256 623 A1 (Procter & Gamble) provides a kit composed of at least two pouches with different composition and different appearance. The pouches are present separately from one another and not as a compact individual product.

A process for producing multichamber pouches by adhesive-bonding of two individual chambers is described by the international application WO 02/85736 A1 (Reckitt Benckiser).

It was an object of the present application to provide a process for producing washing or cleaning compositions which enables the combined formulation of solid and liquid or free-flowing washing or cleaning compositions in mutually separate regions of a compact dosage unit. The process end product should be notable for an attractive appearance.

It has now been found that the aforementioned objects are achieved by a process in which a washing- or cleaning-active molding with a cavity is provided, and a thermoformed body is formed in this cavity and can then be filled.

A process for producing a dosage unit for washing or cleaning compositions, comprising the steps of
a) providing a molding having at least one cavity;
b) applying a first film material onto the molding surface over the opening of the cavity;
c) thermoforming the first film material into the cavity;
d) introducing a washing- or cleaning-active substance onto the film material in the cavity.

In the first step of the process according to the invention, a molding is provided. Such moldings are obtainable, for example, by compacting processes such as tableting, by extrusion such as strand extrusion, by injection molding processes or by casting processes. Particular preference is given in the context of the present application to moldings which are prepared by tableting or by casting processes. The moldings comprise or consist of washing- or cleaning-active substances or substance mixtures.

Washing or cleaning composition tablets are produced in the manner known to those skilled in the art by compressing particulate starting substances. To produce the tablets, the premixture is compacted in a die between two punches to form a solid compact. This operation, which is referred to below as tableting for short, divides into four sections: dosage, compaction (elastic deformation), plastic deformation and expulsion. The tableting is preferably effected on rotary tableting presses.

In the case of tableting with rotary tableting presses, it has been found to be advantageous to perform the tableting with minimum weight deviations of the tablet. In this way, it is also possible to reduce the hardness variations of the tablet. Low weight variations can be achieved in the following way:
use of plastic inlays having low thickness tolerances
low rotational speed of the rotor
large filling shoe
adjustment of the rotational speed of the filling shoe vane to the rotational speed of the rotor
filling shoe with constant powder height
decoupling of filling shoe and powder reservoir.

To reduce caking on the punches, it is possible to use all antiadhesion coatings known from the prior art. Plastic coatings, plastic inlays or plastic punches are particularly advantageous. Rotary punches have also been found to be advantageous, in which case upper and lower punches should be designed so as to be rotatable if possible. In the case of rotating punches, it is generally possible to dispense with a plastic inlay. Here, the punch surfaces should be electropolished.

Processes preferred in the context of the present invention are characterized in that the compression is effected at pressures of from 0.01 to 50 kNcm⁻², preferably from 0.1 to 40 kNcm⁻² and in particular from 1 to 25 kNcm⁻².

Inventive preferred castings are produced, for example, by casting a washing- or cleaning-active formulation in a mold and subsequently demolding the solidified cast body to form a (cavity) molding. The “molds” used are preferably molds which have cavities which can be filled with castable substances. Such molds may, for example, be in the form of individual cavities or else in the form of plates with a plurality of cavities. The individual cavities or cavity plates are, in industrial processes, preferably mounted on horizontal conveyor belts which enable continuous or discontinuous transport of the cavities, for example along a series of different working stations (for example: casting, cooling, filling, sealing, demolding, etc.).

In the preferred process, the washing- or cleaning-active formulations are cast and then solidified to form a dimensionally stable body. In the context of the present invention, “solidified” indicates any hardening mechanism which affords a body solid at room temperature from a deformable, preferably free-flowing mixture or such a substance or such a material, without pressing or compacting forces being necessary. “Solidifying” in the context of the present invention is therefore, for example, the hardening of melts of substances solid at room temperature by cooling. In the context of the present application, “solidification operations” are also the hardening of deformable materials by time-delayed water binding, by evaporation of solvents, by chemical reaction, crystallization, etc., and also the reactive hardening of free-flowing powder mixtures to give stable hollow bodies.

Suitable formulations for processing in the process described are generally all washing- or cleaning-active formulations which can be processed by casting techniques. However, particular preference is given to using washing- or cleaning-active formulations in the form of dispersions. In a particularly preferred embodiment of the present application, the washing- or cleaning-active formulation cast into the receiving depression of the mold is a dispersion of solid particles in a dispersant, particular preference being given to dispersions which, based on their total weight, contain

i) from 10 to 85% by weight of dispersant and

ii) from 15 to 90% by weight of dispersed substances.

In this application, a dispersion refers to a system of a plurality of phases of which one is a continuous phase (dispersant) and at least one a further finely divided phase (dispersed substances).

In the context of the present invention, suitable dispersants are preferably the water-soluble or water-dispersible polymers, especially the water-soluble or water-dispersible nonionic polymers. The dispersant may be either an individual polymer or mixtures of different water-soluble or water-dispersible polymers. In a further preferred embodiment of the present invention, the dispersant, or at least 50% by weight of the polymer mixture, consists of water-soluble or water-dispersible nonionic polymers from the group of the polyvinylpyrrolidones, vinylpyrrolidone/vinyl ester copolymers, cellulose ethers, polyvinyl alcohols, polyalkylene glycols, especially polyethylene glycol and/or polypropylene glycol.

Particular preference is given to using dispersions which comprise, as a dispersant, a nonionic polymer, preferably a poly(alkylene)glycol, preferentially a poly(ethylene)glycol and/or a poly(propylene)glycol, the proportion by weight of the poly(ethylene)glycol in the total weight of all dispersants being preferably between 10 and 90% by weight, more preferably between 30 and 80% by weight and in particular between 50 and 70% by weight. Particular preference is given to dispersions in which the dispersant consists to an extent of more than 92% by weight, preferably to an extent of more than 94% by weight, more preferably to an extent of more than 96% by weight, even more preferably to an extent of more than 98% by weight and in particular to an extent of 100% by weight of a poly(alkylene)glycol, preferably poly(ethylene)glycol and/or poly(propylene)glycol, but in particular poly(ethylene)glycol. Dispersants which, in addition to poly(ethylene)glycol, also comprise poly(propylene)glycol preferably have a ratio of parts by weight of poly(ethylene)glycol to poly(propylene)glycol of between 40:1 and 1:2, preferably between 20:1 and 1:1, more preferably between 10:1 and 1.5:1 and in particular between 7:1 and 2:1.

Further preferred dispersants are the nonionic surfactants which may be used alone, but more preferably in combination with a nonionic polymer. Detailed remarks on the usable nonionic surfactants can be found below in the context of the description of washing- or cleaning-active substances.

Suitable dispersed substances in the context of the present application are all washing- or cleaning-active substances solid at room temperature, but in particular washing- or cleaning-active substances from the group of the builders (builders and cobuilders), the washing- or cleaning-active polymers, the bleaches, the bleach activators, the glass corrosion protectants, the silver protectants and/or the enzymes. A more precise description of these ingredients can be found below in the text.

Dispersions used with preference in accordance with the invention as laundry detergent or cleaning composition tablets feature dissolution in water (40° C.) within less than 9 minutes, preferably less than 7 minutes, preferentially within less than 6 minutes, more preferably within less than 5 minutes and in particular within less than 4 minutes. To determine the solubility, 20 g of the dispersion are introduced into the interior of a machine dishwasher (Miele G 646 PLUS). The main wash cycle of a standard wash program (45° C.) is started. The solubility is determined by the measurement of the conductivity, which is recorded by means of a conductivity sensor. The dissolution procedure has ended on attainment of the conductivity maximum. In the conductivity diagram, this maximum corresponds to a plateau. The conductivity measurement begins with the use of the circulation pump in the main wash cycle. The amount of water used is 5 liters.

The moldings produced, for example, by tableting or casting may assume any geometric shape, preference being given in particular to concave, convex, biconcave, biconvex, cubic, tetragonal, orthorhombic, cylindrical, spherical, cylinder segment-like, disk-shaped, tetrahedral, dodecahedral, octahedral, conical, pyramidal, ellipsoidal, pentagonally, heptagonally and octagonally prismatic, and rhombohedral shapes. It is also possible to realize entirely irregular outlines such as arrow or animal shapes, trees, clouds, etc. When the inventive tablets have corners and edges, these are preferably rounded off. As an additional visual differentiation, preference is given to an embodiment with rounded corners and beveled (chamfered) edges.

The moldings can of course also be produced in multiphase form. For reasons of process economics, two-layer or three-layer moldings, especially two-layer or three-layer tablets, have been found to be particularly useful here.

In a particularly preferred embodiment, in step a) of the process according to the invention, the moldings used are tablets and/or compactates, for example roll compactates, and/or extrudates and/or injection moldings and/or castings and/or moldings composed of these moldings.

To improve its molding appearance and/or to influence its dissolution behavior, the molding may have a coating. The coating may cover either the entire molding or individual regions of the molding. Particular preference is given to moldings which have a coating over their entire surface. Preference is further given to moldings in which the coating extends only over individual surfaces of the molding, for example the molding surfaces outside the cavity, or over individual corners or edges of the molding.

Suitable coating materials are all materials known to the person skilled in the art for this purpose. Preferred coating materials in the context of the present application are the water-soluble or water-insoluble natural or synthetic organic polymers, particular preference being given to water-soluble or water-dispersible organic polymers. Also suitable for the coating of the moldings are the salts of organic or inorganic acids. Among the group of the organic acids, preference is given here in particular to the salts of the mono-, di-, tri-, tetra- or polycarboxylic acids.

Preferred processes according to the invention are accordingly characterized in that the molding has a coating.

In the context of the present invention, the term “cavity” indicates either depressions or apertures or holes which pass through the molding and join two sides of the molding, preferably opposite sides of the molding, for example the bottom and top surface of the molding, to one another.

The shape of the cavity, which is preferably a depression, can be selected freely, preference being given to tablets in which at least one depression has a concave, convex, cubic, tetragonal, orthorhombic, cylindrical, spherical, cylinder segment-like, disk-shaped, tetrahedral, dodecahedral, octahedral, conical, pyramidal, ellipsoidal, pentagonally, heptagonally and octagonally prismatic, and rhombohedral shape. It is also possible to realise entirely irregular depression shapes, such as arrow or animal shapes, trees, clouds, etc. As in the case of the base moldings too, preference is given to depressions with rounded corners and edges or with rounded corners and chamfered edges. The bottom surface of the depression may be planar or tilted.

In a particularly preferred embodiment, the cavity is an aperture which connects two opposite sides of the molding to one another. A corresponding molding can be referred to as an annulus. The opening surfaces of the aperture in the surface of this annulus may have the same size, but may also differ with regard to their size. When the molding used is a tablet, the molding with such an aperture corresponds to a so-called ring tablet. Particular preference is given to using such moldings with an aperture, in which the opening surfaces of the aperture on the opposite sides of the molding, based on the larger of the two opening surfaces, differ by less than 80%, preferably by less than 60%, preferentially by less than 40%, more preferably by less than 20% and in particular by less than 10%. Particular preference is given to using ring tablets in which the opening surfaces of the aperture have the same size. The cross section of the aperture may be angular or round. Cross sections having one, two, three, four, five, six or more corners are realizable, but particular preference is given in the context of the present application to those moldings which have an aperture without corners, preferably an aperture having a round or oval cross section. “Cross section” refers to a surface which is at right angles to a straight connecting line between the centers of the two opposite opening surfaces of the molding.

Of course, the molding may also have more than one cavity. Particular preference is given in the context of the present application to moldings having two, three, four, five, six, seven, eight, nine, ten, eleven, twelve or more cavities. When the molding has more than one cavity, these cavities may either be the above-described depressions or the above-described apertures. Particular preference is given in the context of the present application to moldings which have more than one cavity, at least one of the cavities being a depression and at least one other of the cavities being an aperture.

The volume of the cavity is preferably between 0.1 and 20 ml, preferably between 0.2 and 15 ml, more preferably between 1 and 10 ml and in particular between 2 and 7 ml.

Before a film material is placed in step b) onto the cavities of the moldings provided in step a), these cavities may, in a preferred process variant, be filled partly with a solid or liquid washing- or cleaning-active substance. Particular preference is given in the context of this application to those processes in which the cavity of the molding, before the first film material is placed on in step b), is filled partly with a washing- or cleaning-active substance. In the context of the present application, preference is given to using, between steps a) and b), free-flowing washing- and cleaning-active formulations, preferably liquid(s), especially melts, and/or gel(s) and/or powder and/or granule(s) and/or extrudate(s) and/or compactate(s).

Before the first film material is laid on in step b), particular preference is given to filling the cavity partly with a washing- or cleaning-active powder, granule or extrudate.

In the present application, the term “liquid” denotes substances or substance mixtures, and equally solutions or suspensions which are present in the liquid state of matter.

Powder is a general term for a form of comminution of solid substances and/or substance mixtures which is obtained by comminution, i.e. trituration or grinding in a mortar (pulverizing), grinding in mills, or as a consequence of atomization or freeze-drying. A particularly fine division is often known as atomization or micronization; the corresponding powders are referred to as micropowders.

According to particle size, a rough division of the powders into coarse, fine and ultrafine powders is customary; pulverulent bulk materials are classified more precisely via their apparent density and by sieve analysis. However, powders preferred in the context of the present application have lower particle sizes below 5000 μm, preferably less than 3000 μm, more preferably less than 1000 μm, even more preferably between 50 and 1000 μm and in particular between 100 and 800 μm.

Powders can be compacted and agglomerated by extrusion, pressing, rolling, briqueting, pelletizing and related processes. Any method known in the prior art for agglomerating particulate mixtures is suitable in principle for preparing the solids present in the inventive compositions. Agglomerates used as solid(s) with preference in the context of the present invention are, in addition to the granules, the compactates and extrudates.

Granules refer to accumulations of small granule particles. A granule particle is an asymmetric aggregate of powder particles. Granulation processes are described widely in the prior art. Granules can be produced by wet granulation, by dry granulation or compaction, and by melt solidification granulation.

The most commonly used granulation technique is wet granulation, since this technique is subject to the fewest restrictions and leads the most reliably to granules with favorable properties. Wet granulation is effected by moistening the powder mixtures with solvents and/or solvent mixtures and/or solutions of binders and/or solutions of adhesives, and is preferably performed in mixers, fluidized beds or spray towers, in which case said mixers may be equipped, for example, with stirring and kneading tools. However, it is also possible to use combinations of fluidized bed(s) and mixer(s) for the granulation, or combinations of various mixers. Depending on the starting material and the product properties desired, the granulation is effected under the action of low to high shear forces.

When the granulation is effected in a spray tower, the starting materials used may, for example, be melts (melt solidification) or preferably aqueous slurries (spray-drying) of solid substances, which are sprayed in at the top of a tower in defined particle size, solidify or dry in free fall and are obtained as granule at the bottom of the tower. Melt solidification is suitable generally particularly for the shaping of low-melting substances which are stable in the region of the melting point (for example urea, ammonium nitrate and various formulations such as enzyme concentrates, medicaments, etc.); the corresponding granules are also referred to as prills. Spray drying is used particularly for the production of washing compositions or washing composition constituents.

Further agglomeration techniques described in the prior art are extruder or perforated roll granulations, in which powder mixtures optionally admixed with granulation fluid are deformed plastically in the course of pressing through perforated disks (extrusion) or on perforated rolls. The products of the extruder granulation are also referred to as extrudates.

Suitable ingredients of the washing- or cleaning-active formulations introduced into the cavities between steps a) and b) are in particular builders, enzymes, bleaches, bleach activators, bleach catalysts, silver protectants or glass corrosion inhibitors. Particular preference is given to introducing bleaches, especially peroxygen compounds such as percarbonates or perborates, bleach activators or silver protectants. These ingredients are preferably introduced into the cavity as a constituent of solid washing- or cleaning-active formulations between steps a) and b). These ingredients are described in detail below in the text. To avoid repetitions, reference is made to the remarks there.

The present application therefore preferably further provides a process for producing a dosage unit for washing or cleaning compositions, comprising the steps of
a) providing a molding having at least one cavity;
a′) partial filling of the cavity with a washing- or cleaning-active composition, preferably a solid washing- or cleaning-active composition, which more preferably comprises at least one substance from the group of the builders, enzymes, bleaches, bleach activators, bleach catalysts, silver protectants and glass corrosion inhibitors;
b) applying a first film material onto the molding surface over the opening of the cavity;
c) thermoforming the first film material into the cavity;
d) introducing a washing- or cleaning-active substance onto the film material in the cavity.

The volume of the substances introduced between steps a) and b) is preferably between 0.5 and 12 ml, more preferably between 0.5 and 8 ml, even more preferably between 0.5 and 6 ml and in particular between 0.5 and 4 ml. The cavity of the molding is preferably filled between 1 and 80% by volume, preferably between 5 and 60% by volume, very particularly between 10 and 50% by volume and in particular between 20 and 50% by volume.

In step b) of the process according to the invention, a film material is placed onto the molding surface over the opening of the cavity. In a preferred embodiment of the process according to the invention, the first film material used in step b) is a water-soluble or water-dispersible film material, preferably a polymeric water-soluble or water-dispersible film material.

In a preferred process variant, the film material in step b) comprises one or more water-soluble polymer(s), preferably a material from the group of (optionally acetalized) polyvinyl alcohol (PVAL), polyvinylpyrrolidone, polyethylene oxide, gelatin, cellulose, and derivatives and mixtures thereof.

“Polyvinyl alcohols” (abbreviation PVAL, occasionally also PVOH) is the name for polymers of the general structure 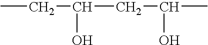
which also comprise structural units of the 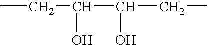
type in small fractions (approx. 2%)

Commercial polyvinyl alcohols, which are supplied as white-yellowish powders or granules with degrees of polymerization in the range from approx. 100 to 2500 (molar masses from approx. 4000 to 100 000 g/mol), have degrees of hydrolysis of 98-99 or 87-89 mol %, and thus also comprise a residual content of acetyl groups. The polyvinyl alcohols are characterized on the part of the manufacturer by specifying the degree of polymerization of the starting polymer, the degree of hydrolysis, the hydrolysis number or the solution viscosity.

Depending on the degree of hydrolysis, polyvinyl alcohols are soluble in water and a few strongly polar organic solvents (formamide, dimethylformamide, dimethyl sulfoxide); they are not attacked by (chlorinated) hydrocarbons, esters, fats and oils. Polyvinyl alcohols are classified as toxicologically safe and are at least partially biodegradable. The water solubility can be reduced by aftertreatment with aldehydes (acetalization), by complexing with nickel or copper salts or by treatment with dichromates, boric acid or borax. The coatings made of polyvinyl alcohol are largely impenetratable to gases such as oxygen, nitrogen, helium, hydrogen, carbon dioxide, but allow steam to pass through.

In the context of the present invention, it is preferred that the film material used in the process according to the invention comprises at least in part a polyvinyl alcohol whose degree of hydrolysis is from 70 to 100 mol %, preferably from 80 to 90 mol %, more preferably from 81 to 89 mol % and in particular from 82 to 88 mol %. In a preferred embodiment, the first film material used in the process according to the invention consists to an extent of at least 20% by weight, more preferably to an extent of at least 40% by weight, even more preferably to an extent of at least 60% by weight and in particular to an extent of at least 80% by weight of a polyvinyl alcohol whose degree of hydrolysis is from 70 to 100 mol %, preferably from 80 to 90 mol %, more preferably from 81 to 89 mol % and in particular from 82 to 88 mol %.

The film materials used are preferably polyvinyl alcohols of a certain molecular weight range, preference being given in accordance with the invention to the film material comprising a polyvinyl alcohol whose molecular weight is in the range from 10 000 to 100 000 gmol⁻¹, preferably from 11 000 to 90 000 gmol⁻¹, more preferably from 12 000 to 80 000 gmol⁻¹ and in particular from 13 000 to 70 000 gmol⁻¹.

The degree of polymerization of such preferred polyvinyl alcohols is between about 200 and about 2100, preferably between about 220 and about 1890, more preferably between about 240 and about 1680 and in particular between about 260 and about 1500.

The polyvinyl alcohols described above are widely available commercially, for example under the trade name Mowiol® (Clariant). Polyvinyl alcohols which are particularly suitable in the context of the present invention are, for example, Mowiol® 3-83, Mowiol® 4-88, Mowiol® 5-88 and Mowiol® 8-88.

Further polyvinyl alcohols which are particularly suitable as a film material can be taken from the table below:

| | Degree of | Molar mass | Melting point |
|---|---|---|---|
| Name | hydrolysis [%] | [kDa] | [° C.] |
| Airvol ® 205 | 88 | 15-27 | 230 |
| Vinex ® 2019 | 88 | 15-27 | 170 |
| Vinex ® 2144 | 88 | 44-65 | 205 |
| Vinex ® 1025 | 99 | 15-27 | 170 |
| Vinex ® 2025 | 88 | 25-45 | 192 |
| Gohsefimer ® 5407 | 30-28 | 23 600 | 100 |
| Gohsefimer ® LL02 | 41-51 | 17 700 | 100 |

Further polyvinyl alcohols suitable as a film material are ELVANOL® 51-05, 52-22, 50-42, 85-82, 75-15, T-25, T-66, 90-50 (trademark of Du Pont), ALCOTEX® 72.5, 78, B72, F80/40, F88/4, F88/26, F88/40, F88/47 (trademark of Harlow Chemical Co.), Gohsenol® NK-05, A-300, AH-22, C-500, GH-20, GL-03, GM-14L, KA-20, KA-500, KH-20, KP-06, N-300, NH-26, NM11Q, KZ-06 (trademark of Nippon Gohsei K.K.).

The water solubility of PVAL can be altered by aftertreatment with aldehydes (acetalization) or ketones (ketalization). In this context, particularly preferred polyvinyl alcohols which are particularly advantageous due to their exceptionally good solubility in cold water have been found to be those which are acetalized or ketalized with the aldehyde and keto groups, respectively, of saccharides or polysaccharides or mixtures thereof. The reaction products of PVAL and starch can be used exceptionally advantageously.

In addition, the solubility in water can be altered by complexation with nickel or copper salts or by treatment with dichromates, boric acid, borax, and thus be adjusted in a controlled manner to desired values. Films of PVAL are largely impenetratable to gases such as oxygen, nitrogen, helium, hydrogen, carbon dioxide, but allow steam to pass through.

Examples of suitable water-soluble PVAL films are the PVAL films obtainable under the name “SOLUBLON®” from Syntana Handelsgesellschaft E. Harke GmbH & Co. Their solubility in water can be adjusted to a precise degree, and films of this product series are obtainable which are soluble in the aqueous phase in all temperature ranges relevant for the application.

Polyvinylpyrrolidones, referred to for short as PVP, can be described by the following general formula:

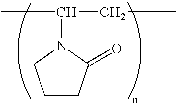

PVPs are prepared by free-radical polymerization of 1-vinylpyrrolidone. Commercially available PVPs have molar masses in the range from approx. 2500 to 750 000 g/mol and are supplied as white, hygroscopic powders or as aqueous solutions.

Polyethylene oxides, PEOX for short, are polyalkylene glycols of the general formula
H—[O—CH₂—CH₂]ₙ—OH
which are prepared industrially by base-catalyzed polyaddition of ethylene oxide (oxirane) in systems containing usually small amounts of water, with ethylene glycol as the starter molecule. They have molar masses in the range from about 200 to 5 000 000 g/mol, corresponding to degrees of polymerization n of from about 5 to >100 000. Polyethylene oxides have an exceptionally low concentration of reactive hydroxyl end groups and exhibit only weak glycol properties.

Gelatin is a polypeptide (molar mass: from approx. 15 000 to >250 000 g/mol) which is obtained primarily by hydrolysis of the collagen present in skin and bores of animals under acidic or alkaline conditions. The amino acid composition of the gelatin corresponds substantially to that of the collagen from which it has been obtained and varies depending on its provenance.

In the context of the present invention, preference is also given to film materials which comprise a polymer from the group of starch and starch derivatives, cellulose and cellulose derivatives, in particular methylcellulose and mixtures thereof.

Starch is a homoglycan, the glucose units being linked α-glycosidically. Starch is made up of two components of different molecular weight: of from approx. 20 to 30% of straight-chain amylose (MW from approx. 50 000 to 150 000) and from 70 to 80% of branched-chain amylopectin (MW from approx. 300 000 to 2 000 000). In addition, small amounts of lipids, phosphoric acid and cations are also present. While the amylose forms long, helical, intertwined chains having from approx. 300 to 1200 glucose molecules owing to the binding in the 1,4-arrangement, the chain branches in the case of amylopectin after, on average, 25 glucose units by a 1,6-bond to give a branch-like structure having from about 1500 to 12 000 molecules of glucose. In addition to pure starch, suitable substances for the preparation of water-soluble coatings of the laundry detergent, dishwasher detergent and cleaning composition portions in the context of the present invention are also starch derivatives which are obtainable from starch by polymer-like reactions. Such chemically modified starches include, for example, products of esterifications or etherifications in which hydroxyl hydrogen atoms have been substituted. However, starches in which the hydroxyl groups have been replaced by functional groups which are not bonded via an oxygen atom can also be used as starch derivatives. The group of starch derivatives includes, for example, alkali metal starches, carboxymethyl starch (CMS), starch esters and starch ethers, and also amino starches.

Pure cellulose has the formal gross composition (C₆H₁₀O₅)ₙ and, considered in a formal sense, constitutes a β-1,4-polyacetal of cellobiose which is itself formed from two molecules of glucose. Suitable celluloses consist of from approx. 500 to 5000 glucose units and accordingly have average molar masses of from 50 000 to 500 000. Cellulose-based disintegrants usable in the context of the present invention also include cellulose derivatives which are obtainable from cellulose by polymer-like reactions. Such chemically modified celluloses comprise, for example, products of esterifications or etherifications in which hydroxyl hydrogen atoms have been substituted. However, celluloses in which the hydroxyl groups have been replaced by functional groups which are not bonded via an oxygen atom can also be used as cellulose derivatives. The group of cellulose derivatives includes, for example, alkali metal celluloses, carboxymethylcellulose (CMC), cellulose esters and cellulose ethers, and also aminocelluloses.

Further preferred film materials are characterized in that they comprise hydroxypropylmethylcellulose (HPMC) which has a degree of substitution (average number of methoxy groups per anhydroglucose unit of the cellulose) of from 1.0 to 2.0, preferably from 1.4 to 1.9, and a molar substitution (average number of hydroxypropoxy groups per anhydroglucose unit of the cellulose) of from 0.1 to 0.3, preferably from 0.15 to 0.25.

Preferred processes according to the invention are characterized in that at least one of the film materials used is transparent or translucent.

The film material used, for example, for thermoforming and/or sealing is preferably transparent. In the context of this invention, transparency means that the transmittance within the visible spectrum of light (410 to 800 nm) is greater than 20%, preferably greater than 30%, exceptionally preferably greater than 40% and in particular greater than 50%. Thus, as soon as one wavelength of the visible spectrum of light has a transmittance greater than 20%, it should be considered as transparent in the context of the invention.

Compositions produced in accordance with the invention, which have been produced using transparent film material, may comprise a stabilizer. In the context of the invention, stabilizers are materials which protect the ingredients at least partly enclosed by the film material from decomposition or deactivation by incident light. It has been found that antioxidants, UV absorbers and fluorescent dyes are particularly suitable here.

In the context of the invention, particularly suitable stabilizers are the antioxidants. In order to prevent undesired changes to the formulations caused by incident light and thus free-radical decomposition, the formulations may comprise antioxidants. The antioxidants used may be, for example, phenols, bisphenols and thiobisphenols substituted by sterically hindered groups. Further examples are propyl gallate, butylhydroxytoluene (BHT), butylhydroxyanisole (BHA), t-butylhydroquinone (TBHQ), tocopherol and the long-chain (C8-C22) esters of gallic acid, such as dodecyl gallate. Other substance classes are aromatic amines, preferably secondary aromatic amines and substituted p-phenylenediamines, phosphorus compounds with trivalent phosphorus, such as phosphines, phosphites and phosphonites, citric acids and citric acid derivatives such as isopropyl citrate, compounds containing enediol groups, known as reductones, such as ascorbic acid and derivatives thereof such as ascorbyl palmitate, organosulfur compounds such as the esters of 3,3′-thiodipropionic acid with C₁₋₁₈-alkanols, especially C₁₀₋₁₈-alkanols, metal ion deactivators which are capable of complexing the autoxidation-catalyzing metal ions, for example copper, such as nitrilotriacetic acid, and derivatives and mixtures thereof. Antioxidants may be present in the formulations in amounts of up to 35% by weight, preferably up to 25% by weight, more preferably from 0.01 to 20% by weight and in particular from 0.03 to 20% by weight.

A further class of stabilizers which can be used with preference is that of the UV absorbers. UV absorbers can improve the photostability of the formulation constituents. They include organic substances (light protection filters) which are capable of absorbing ultraviolet rays and emitting the energy absorbed again in the form of longer-wavelength radiation, for example heat. Compounds which have these desired properties are, for example, the compounds and derivatives of benzophenone having substituents in the 2- and/or 4-position which are effective by virtue of radiationless deactivation. Also suitable are substituted benzotriazoles, for example the water-soluble monosodium 3-(2H-benzotriazol-2-yl)-4-hydroxy-5-(methylpropyl)benzenesulfonate (Cibafast® H), 3-phenyl-substituted acrylates (cinnamic acid derivatives), optionally having cyano groups in the 2-position, salicylates, organic nickel complexes and natural substances such as umbelliferone and endogenous urocanic acid. Of particular significance are biphenyl and in particular stilbene derivatives which are available commercially as Tinosorb® FD or Tinosorb® FR ex Ciba. UV-B absorbers include 3-benzylidenecamphor or 3-benzylidenenorcamphor and derivatives thereof, for example 3-(4-methylbenzylidene)camphor; 4-aminobenzoic acid derivatives, preferably 2-ethylhexyl 4-(dimethylamino)benzoate, 2-octyl 4-(dimethylamino)benzoate and amyl 4-(dimethylamino)benzoate; esters of cinnamic acid, preferably 2-ethylhexyl 4-methoxycinnamate, propyl 4-methoxycinnamate, isoamyl 4-methoxycinnamate, 2-ethylhexyl 2-cyano-3,3-phenylcinnamate(octocrylene); esters of salicylic acid, preferably 2-ethylhexyl salicylate, 4-isopropylbenzyl salicylate, homomethyl salicylate; derivatives of benzophenone, preferably 2-hydroxy-4-methoxybenzophenone, 2-hydroxy-4-methoxy-4′-methylbenzophenone, 2,2′-dihydroxy-4-methoxybenzophenone; esters of benzalmalonic acid, preferably di-2-ethylhexyl 4-methoxybenzomalonate; triazine derivatives, for example 2,4,6-trianilino(p-carbo-2′-ethyl-1′-hexyloxy)-1,3,5-triazine and octyltriazone or dioctylbutamidotriazone (Uvasorb® HEB); propane-1,3-diones, for example 1-(4-tert-butylphenyl)-3-(4′-methoxyphenyl)propane-1,3-dione; ketotricyclo(5.2.1.0)decane derivatives. Also suitable are 2-phenylbenzimidazole-5-sulfonic acid and the alkali metal, alkaline earth metal, ammonium, alkylammonium, alkanolammonium and glucammonium salts thereof; sulfonic acid derivatives of benzophenones, preferably 2-hydroxy-4-methoxybenzophenone-5-sulfonic acid and its salts; sulfonic acid derivatives of 3-benzylidenecamphor, for example 4-(2-oxo-3-bornylidenemethyl)-benzenesulfonic acid and 2-methyl-5-(2-oxo-3-bornylidene)sulfonic acid and salts thereof.

Useful typical UV-A filters are in particular derivatives of benzoylmethane, for example 1-(4′-tert-butylphenyl)-3-(4′-methoxyphenyl)propane-1,3-dione, 4-tert-butyl-4′-methoxydibenzoylmethane (Parsol 1789), 1-phenyl-3-(4′-isopropylphenyl)propane-1,3-dione, and enamine compounds. The UV-A and UV-B filters can of course also be used in mixtures. In addition to the soluble substances mentioned, insoluble light protection pigments are also suitable for this purpose, specifically finely dispersed, preferably nanoized, metal oxides or salts. Examples of suitable metal oxides are in particular zinc oxide and titanium dioxide and additionally oxides of iron, zirconium, silicon, manganese, aluminum and cerium, and mixtures thereof. The salts used may be silicates (talc), barium sulfate or zinc stearate. The oxides and salts are already used in the form of pigments for skincare and skin-protecting emulsions and decorative cosmetics. The particles should have an average diameter of less than 100 nm, preferably between 5 and 50 nm and in particular between 15 and 30 nm. They may have a spherical shape, although it is also possible to use particles which have an ellipsoidal shape or a shape which deviates in some other way from the spherical form. The pigments may also be surface-treated, i.e. hydrophilicized or hydrophobicized. Typical examples are coated titanium dioxides, for example titanium dioxide T 805 (Degussa) or Eusolex® T2000 (Merck). Suitable hydrophobic coating compositions are in particular silicones and especially trialkoxyoctylsilanes or simethicones. Preference is given to using micronized zinc oxide.

A further class of stabilizers to be used with preference is that of the fluorescent dyes. They include the 4,4′-diamino-2,2′-stilbenedisulfonic acids (flavone acids), 4,4′-distyrylbiphenyls, methylumbelliferones, coumarins, dihydroquinolinones, 1,3-diarylpyrazolines, naphthalimides, benzoxazole, benzisoxazole and benzimidazole systems, and pyrene derivatives substituted by heterocycles. Of particular significance in this connection are the sulfonic acid salts of diaminostilbene derivatives, and polymeric fluorescent substances.

Preferred process variants are characterized in that the film materials used in step b) of the process according to the invention have a thickness between 5 and 2000 μm, preferably between 10 and 1000 μm, more preferably between 15 and 500 μm, even more preferably between 20 and 200 μm and in particular between 25 and 100 μm.

The films used may be single-layer or multilayer films (laminate films). Irrespective of their chemical or physical structure, the water content of the film materials is preferably below 10% by weight, more preferably below 7% by weight, even more preferably below 5% by weight and in particular below 4% by weight.

In step c) of the process according to the invention, the first film material is thermoformed into the cavity.

In a preferred process variant, the packaging film used is conditioned before the deformation. Particular preference is given to those processes according to the invention in which the packaging film is pretreated by heating and/or solvent application before being thermoformed in step c). When the film material is pretreated by the action of heat before or during the thermoforming into the cavity of the molding, this is preferably done by heating it to temperatures above 60° C., preferably above 80° C., more preferably between 100 and 120° C. and in particular to temperatures between 105 and 115° C. for up to 5 seconds, preferably for from 0.1 to 4 seconds, more preferably for from 0.2 to 3 seconds and in particular for from 0.4 to 2 seconds. Film materials pretreated in this way, in preferred process variants, are deformed into the cavity of the molding in step c) merely on the basis of their intrinsic weight.

Particular preference is further given to those processes in which the first film material is thermoformed into the cavity in step c) by generating a reduced pressure in the cavity of the molding.

To generate this reduced pressure, suitable pumps are all of those known to the person skilled in the art for these purposes; especially preferred are the water-jet, liquid vapor-jet, water-ring and piston pumps usable for a coarse vacuum. However, it is also possible with preference, for example, to use rotary vane pumps, rotary piston pumps, trochoid pumps and sorption pumps, and also so-called Roots pumps and cryopumps. For the establishment of a fine vacuum, preference is given to rotary vane pumps, diffusion pumps, Roots pumps, displacer pumps, turbomolecular pumps, sorption pumps, ion getter pumps (getters).

In a preferred embodiment of the process according to the invention, the reduced pressure generated is between −100 and −1013 mbar, preferably between −200 and −1013 mbar, more preferably between −400 and −1013 mbar and in particular between −800 and −1013 mbar.

The reduced pressure can be generated in the cavity by various procedures. In the simplest case, the cavity is one of the apertures described at the outset. Application of a reduced pressure to one of the openings of the aperture which has not been covered in step b) by a first film material allows the film material to be thermoformed into the cavity.

In the context of the present application preference is accordingly given to a process for producing a dosage unit for washing or cleaning compositions, comprising the steps of
a) providing a molding having at least one cavity in the form of an aperture;
b) applying a first film material onto the molding surface over the opening of the aperture;
c) thermoforming the first film material into the aperture by applying a reduced pressure to an opening of the aperture which is not covered by the first film material;
d) introducing a washing- or cleaning-active substance onto the film material in the cavity.

As explained at the outset, the molding with the aperture is preferably a ring tablet. In a particularly preferred embodiment, the application therefore in particular encompasses a process for producing a dosage unit for washing or cleaning compositions, comprising the steps of
a) providing a ring tablet;
b) applying a first film material onto the molding surface over the opening of the ring tablet;
c) thermoforming the first film material into the cavity of the ring tablet by applying a reduced pressure to the further orifice;
d) introducing a washing- or cleaning-active substance onto the film material in the cavity.

Ring moldings or ring tablets refer to those moldings which have two orifices connected to one another in their surface. These orifices connected to one another form an aperture which penetrates through the body or the tablet, which preferably connects two opposite sides to one another.

When ring tablets are used in the process according to the invention for producing the washing or cleaning composition dosage units, the film material is thermoformed into the aperture of these ring tablets, in a particularly preferred embodiment, after a mold has been introduced into the aperture of the ring tablet. This mold can be introduced into the aperture before or after the first film material is applied to the molding surface over the opening of the ring tablet. Of course, the mold can also be introduced simultaneously with the placing-on of the film material. In this process variant, the mold serves as a “placeholder” and reduces the cavity volume of the aperture into which the film material can be thermoformed. The receiving chamber formed by the thermoforming of the film material will consequently not fill the entire aperture but rather exclusively the cavity volume remaining in the aperture after the introduction of the mold. Consequently, the receiving chamber formed from the film material only partly fills the aperture.

The present application therefore preferably provides a process for producing a dosage unit for washing or cleaning compositions, comprising the steps of
a) providing a ring molding, preferably a ring tablet;
b) introducing a mold through a first opening of the aperture of the ring tablet into this aperture;
c) applying a first, preferably water-soluble film material onto the molding surface over the second opening of the aperture;
d) thermoforming the first film material into the aperture of the ring tablet to form a receiving chamber which fills the aperture only partly;
e) introducing a washing- or cleaning-active substance into the receiving chamber formed in step d).

As already detailed, process steps b) and c) in this preferred process variant may be effected in reverse sequence or else simultaneously.

As a result of the introduction of the mold into the aperture of the ring tablet, this aperture is filled partly but not fully. Preference is given in particular to those processes in which the mold fills between 5 and 95% by volume, preferably between 10 and 90% by volume, preferentially between 15 and 85% by volume and in particular between 20 and 80% by volume of the aperture of the ring tablet.

Suitable materials for producing the molds are in particular metals or metal alloys, and also preferably polymeric plastics. Alternatively, it is of course also possible to use metallic molds with preferably polymeric coatings. Such coatings are suitable, for example, for increasing the chemical or physical stability of the molds, for instance against corrosion or mechanical stress. Polymeric coatings are also suitable for preventing adhesions on the surface of the mold.

In preferred processes, the mold introduced into the aperture of the ring tablet is, with regard to its three-dimensional shape, adjusted to the three-dimensional shape of the aperture of the ring tablet. Thus, the mold is preferably tight to the inner wall of the ring tablet, i.e. to the wall of the aperture. Preference is given in particular to those processes in which the distance between the mold introduced into the aperture and the inner wall of the ring tablet is less than 10 mm, preferably less than 5 mm, preferentially less than 3 mm and in particular between 0.1 and 2 mm.

The mold preferably has a rotationally symmetric horizontal cross section. Particularly preferred molds feature a triagonal or tetragonal, preferably square, horizontal cross section. The corners of these molds are preferably rounded off. In an alternative, equally preferred embodiment, the horizontal cross section of the mold introduced into the ring molding is oval or circular.

The upper side of the mold, i.e. the side of the mold facing toward the first film material laid onto the opening of the ring tablet, can be configured in different ways. Since the film material applied to the opening of the ring tablet in step c), in step d) of this preferred embodiment, is thermoformed into the aperture filled at least partly by the mold, preferably thermoformed in such a way that this film material is tightly adjacent to the upper side of the mold, it is also possible to influence the three-dimensional configuration of the bottom surface of the receiving chamber produced by the thermoforming operation directly by the three-dimensional configuration of the upper side of the molding. Thus, the use of a mold with a planar upper side results in an essentially planar bottom surface of the receiving chamber, taking into account the shrink-back of the thermoformed film material which occurs naturally in thermoforming processes.

In this process variant, particular preference is given to using molds with planar, concave or convex upper side, but in particular molds with a concave upper side. In a particularly preferred variant, the upper side of the mold has both planar and curved, and concave and/or convex subregions. Very particular preference is given to molds with a circumferential planar edge region and a concave inner part enclosed by this planar edge region, i.e. a depression enclosed by this planar edge region.

Particular preference is given to configuring the mold introduced into the aperture of the ring tablet in such a way that, by applying a reduced pressure to the mold, the gas space between the mold and the film material applied to the opening of the ring tablet can be evacuated. Preferred molds therefore have notches, grooves or bores, by means of which, by applying a reduced pressure, the gas space between the mold and the first film material applied to the opening of the ring tablets can be evacuated at least partly and, in this way, the film material can be thermoformed into the aperture.

When, after the mold has been introduced into the aperture of the ring tablet in step d) of this preferred process variant, the film material is thermoformed into the aperture of the ring tablet, the receiving chamber formed by the thermoforming of the film material can of course fill at a maximum, that space in the aperture which is not occupied by the mold. The introduction of a washing- or cleaning-active substance into this receiving chamber in the next step e) consequently also only partly fills the aperture of the ring tablets. The thermoforming is effected preferably by applying a reduced pressure, but can, for example, also be effected by the action of a punch.

The receiving chamber formed by the thermoforming of the first film material is preferably filled with a free-flowing substance. The free-flowing substances may be solids or liquids, particular preference being given to using liquid(s) and/or gel(s) and/or powder and/or granule(s) and/or extrudate(s) and/or compactate(s). A more precise description of these free-flowing substances is below in the text.

After the filling of the receiving chamber with the washing- or cleaning-active substance, this receiving chamber is preferably sealed. Suitable sealing materials are, for example, solidifying melts or liquids or preferably precisely fitting moldings. With particular preference, the sealing materials used are, however, water-soluble film materials.

The present application therefore further preferably provides a process for producing a dosage unit for washing or cleaning compositions, comprising the steps of
a) providing a ring molding, preferably a ring tablet;
b) introducing a mold through a first opening of the aperture of the ring tablet into this aperture;
c) applying a first, preferably water-soluble film material onto the molding surface over the second opening of the aperture;
d) thermoforming the first film material into the aperture of the ring tablet to form a receiving chamber which fills the aperture only partly;
e) introducing a washing- or cleaning-active substance into the receiving chamber formed in step d);
f) sealing the filled receiving chamber.

To seal and adhesively bond the first film material to the further water-soluble film material, for example, solvents and/or adhesives may be used. With particular preference, however, the sealing is effected by means of the action of heat, preferably by laser welding or heat sealing.

The sealing can in principle be effected in the region of the molding of the ring tablet itself and/or in the region of the aperture. In the first case, the dosage units have a preferably circumferential seal seam which is in direct contact with the molding; in the second case, the preferably circumferential seal seam is in the region of the aperture and does not touch the molding.

As already detailed above, in this preferred process variant, particular preference is given to using molds whose upper sides have a circumferential planar edge region and a concave inner part enclosed by this planar edge region, i.e. a depression enclosed by this planar edge region. With particular preference, the thermoformed first film material is sealed to the further water-soluble film material employed for sealing by means of heat sealing, and the preferably circumferential seal seam which seals the receiving chamber, with particular preference, does not touch the molding, i.e., for example, is generated in the region of the aperture.

The present application thus further preferably provides a process for producing a dosage unit for washing or cleaning compositions, comprising the steps of
a) providing a ring molding, preferably a ring tablet;
b) introducing a mold, whose upper side has a circumferential planar edge region, through a first opening of the aperture of the ring tablet into this aperture;
c) applying a first, preferably water-soluble film material onto the molding surface over the second opening of the aperture;
d) thermoforming the first film material into the aperture of the ring tablet to form a receiving chamber which fills the aperture only partly;
e) introducing a washing- or cleaning-active substance into the receiving chamber formed in step d);
f) sealing the filled receiving chamber by applying a water-soluble film material to the filled receiving chamber and heat-sealing the first film material to the water-soluble film material in the planar edge region of the mold.

As a result of the sealing of the two film materials forming the receiving chamber in the region of the planar edge region of the mold, the imperviousness of the sealed receiving chambers compared to conventional processes can be increased significantly. Particular preference is given to using metallic molds in this process variant. With particular preference, the molds used are heatable.

Completion of the sealing results in washing or cleaning composition dosage units comprising a ring tablet and a filled, preferably water-soluble receiving chamber which partly fills the aperture of the ring tablet. Ring tablet and filled receiving chamber are preferably adhesively bonded to one another. This adhesive bond can be effected, for example, by adhesive-bonding the ring tablet to the first film material laid on over the opening of the ring tablet in step c) or by heat-sealing the first film material to the surface of the ring tablet. The aperture of the ring tablet is not filled below the water-soluble receiving chamber.

In a preferred embodiment of the above-described process variant, the mold, on completion of the sealing, is removed from the aperture and the cavity present in the aperture below the filled receiving chamber is filled with a further, preferably free-flowing, washing- or cleaning-active substance. To this end, the partly filled ring tablet is preferably first turned over. After the filling, the second orifice of the aperture is preferably also sealed, for which particular preference is given in turn to using the sealing materials mentioned above, especially water-soluble film materials.

The present application thus further preferably provides a process for producing a dosage unit for washing or cleaning compositions, comprising the steps of
a) providing a ring molding, preferably a ring tablet;
b) introducing a mold, whose upper side preferably has a circumferential planar edge region, through a first opening of the aperture of the ring tablet into this aperture;
c) applying a first, preferably water-soluble film material onto the molding surface over the second opening of the aperture;
d) thermoforming the first film material into the aperture of the ring tablet down to the upper side of the mold to form a receiving chamber which fills the aperture only partly;
e) introducing a washing- or cleaning-active substance into the receiving chamber formed in step d);
f) sealing the filled receiving chamber by applying a water-soluble film material to the filled receiving chamber and heat-sealing the first, preferably water-soluble, film material to this water-soluble film material, the sealing preferably being effected in the planar edge region of the mold;
g) removing the mold through the first orifice from the aperture of the ring tablet and introducing a further washing- or cleaning-active substance into the region of the aperture that had been occupied by the mold beforehand;
h) sealing the first orifice of the filled aperture with a preferably water-soluble film material.

Particular preference is given to process variants in which, in at least one of process steps e) and h), a washing- or cleaning-active liquid or a washing- or cleaning-active gel is introduced. Very particular preference is given to processes in which a washing- or cleaning-active liquid or a washing- or cleaning-active gel is introduced in step e), while a free-flowing, washing- or cleaning-active solid, preferably a powder or a granule or an extrudate, is introduced in step h).

Irrespective of the nature of the process variant, the first film material is thermoformed in step c) or in step d) of the process according to the invention preferably by applying a reduced pressure. In a further preferred process variant, the reduced pressure in the cavity is generated by applying a reduced pressure to a hole or a notch which connects the cavity to the part of the surface of the molding (outside the cavity) which is not covered by the first film material from step b). Such a hole may, for example, be a bore which connects the cavity to a side surface or the lower side of the molding. Such a bore preferably has a diameter below 5 mm, preferably below 3 mm and in particular below 2 mm. Of course, the cavity can also be connected to one or more outer sides by more than one hole or the molding can also have more than one bore. Alternatively or supplementarily, the molding may also have notches. These notches or grooves open in the opening of the cavity opening and lead from there preferably to a side surface of the molding. The width of these notches is preferably less than 10 mm, preferentially less than 7 mm, more preferably less than 4 mm and in particular less than 2 mm. The depth of the notches is preferably in the range between 1 and 15 mm, preferably between 1 and 10 mm and in particular between 1 and 5 mm.

In a further variant of the process according to the invention, the first film material is thermoformed into the cavity by applying a reduced pressure to a hole or a notch which connects the cavity to the part of the surface of the molding (outside the cavity) which is not covered by the first film material from step b).

This application therefore further preferably provides a process for producing a dosage unit for washing or cleaning compositions, accordingly comprising the steps of
a) providing a molding having at least one cavity in the form of a depression;
a′) optionally partial filling of the depression with a washing- or cleaning-active composition, preferably a solid washing- or cleaning-active composition, which more preferably comprises at least one substance from the group of the builders, enzymes, bleaches, bleach activators, bleach catalysts, silver protectants and glass corrosion inhibitors;
b) applying a first film material onto the molding surface over the opening of the depression;
c) thermoforming the first film material into the depression by applying a reduced pressure to a hole or a notch which connects the depression to the part of the surface of the molding (outside the depression) which is not covered by the first film material from step b);
d) introducing a washing- or cleaning-active substance onto the film material in the depression.

When the molding has sufficient porosity, the reduced pressure in the cavity can be generated by applying a reduced pressure to the molding surface (outside the cavity). It has been found that, surprisingly, the abovementioned washing or cleaning composition tablets are suitable for such a process. By compaction, preferably tableting, of particulate starting mixtures, it is accordingly possible to produce moldings which have sufficient porosity to generate, by applying a reduced pressure at the surface of the molding which is not covered by the film material, a reduced pressure within the cavity which is sufficient to thermoform the film material covering the orifice of the cavity into this cavity.

In a further process variant preferred in accordance with the invention, the first film material is thermoformed into the cavity by applying a reduced pressure to the part of the surface of the mold (outside the cavity) which is not covered by the film material from step b).

This application accordingly further provides a process for producing a dosage unit for washing or cleaning compositions, accordingly comprising the steps of
a) providing a molding having at least one cavity in the form of a depression;
a′) optionally partial filling of the cavity with a washing- or cleaning-active composition, preferably a solid washing- or cleaning-active composition, which more preferably comprises at least one substance from the group of the builders, enzymes, bleaches, bleach activators, bleach catalysts, silver protectants and glass corrosion inhibitors;
b) applying a first film material onto the molding surface over the opening of the cavity;
c) thermoforming the first film material into the cavity by applying a reduced pressure to the part of the surface of the molding (outside the cavity) which is not covered by the film material from step b);
d) introducing a washing- or cleaning-active substance onto the film material in the cavity.

In the preferred process variants described so far, the reduced pressure is generated in the cavity by removing the air present in the cavity below the film material laid on in step b) from this cavity “through the tablet”, i.e. by applying a reduced pressure to bores, notches or holes made especially for this purpose, or with utilization of the tablet porosity. In a further particularly preferred process variant, the reduced pressure is generated in the cavity by removing the air present in the cavity below the film laid on in step b) from the cavity through holes in this film material.

Particular preference is given in the context of this application to processes for producing a dosage unit for washing or cleaning compositions, comprising the steps of
a) providing a molding having at least one cavity;
a′) optionally partial filling of the cavity with a washing- or cleaning-active composition, preferably a solid washing- or cleaning-active composition, which more preferably comprises at least one substance from the group of the builders, enzymes, bleaches, bleach activators, bleach catalysts, silver protectants and glass corrosion inhibitors;
b) applying a first film material onto the molding surface over the opening of the cavity;
c) thermoforming the first film material into the cavity by generating a reduced pressure in the cavity by virtue of the air present in the cavity below the film escaping at least partly through orifices in the film material laid on in step b);
d) introducing a washing- or cleaning-active substance onto the film material in the cavity.

Particular preference is given to processes according to the invention in which the reduced pressure is generated both in the cavity, i.e. below the film material applied in step b), and outside the cavity, above the film material laid on in step b). Such a particularly advantageous process can be realized, for example, by introducing the molding covered with the film material into a reduced-pressure chamber. Owing to the orifices present in the film material, application of a vacuum to the reduced-pressure chamber generates both in the cavity of the molding, i.e. below the film material laid on in step b), and outside the molding, above the film material applied in step b) a reduced pressure, since the air present below the film material applied in step b) passes through these orifices into the space above the film material applied in step b), whence it is removed from the reduced-pressure chamber by the vacuum applied. In a subsequent process step, the film web applied in step b) is sealed to the filled vessel such that the vessel is sealed on all sides and, in particular, no air can pass through the orifices of the film web applied in step c) into the vessel. When the sealed vessel is then removed from the reduced-pressure chamber, the atmospheric pressure acting on the vessel from outside has the effect that the outer walls of the vessel, especially the film web applied in step b), fits closely to the molding into the cavity.

Particular preference is likewise given in the context of this application to processes for producing a dosage unit for washing or cleaning compositions, comprising the steps of
a) providing a molding having at least one cavity;
a′) optionally partial filling of the cavity with a washing- or cleaning-active composition, preferably a solid washing- or cleaning-active composition, which more preferably comprises at least one substance from the group of the builders, enzymes, bleaches, bleach activators, bleach catalysts, silver protectants and glass corrosion inhibitors;
b) applying a first film material onto the molding surface over the opening of the cavity;
c) thermoforming the first film material into the cavity by introducing the molding covered with the film web into a reduced-pressure chamber and generating a reduced pressure in this chamber, which generates a reduced pressure in the cavity by virtue of the air present in the cavity below the film escaping at least partly through orifices in the film material applied in step b);
d) introducing a washing- or cleaning-active substance onto the film material in the cavity.

As a result of the thermoforming of the film material into the cavity in step c) of the process according to the invention, the film material is deformed into the cavity to form a receiving depression. This receiving depression is then filled with a washing- or cleaning-active substance in the next step d). The shape and the volume of the receiving depression will naturally be guided by the shape and the volume of the cavity of the molding underlying the process. Preference is given in particular to those processes in which the volume of the receiving depression formed by the film material constitutes at least 40% by volume, preferably at least 60% by volume, even more preferably at least 80% by volume, in particular at least 90% by volume and especially preferably at least 95% by volume of the volume of the cavity of the molding in step a) or in step a′).

To spatially fix molding and film material before the subsequent filling in step d), the molding and the film material, in a preferred embodiment of the process according to the invention, are adhesively bonded to one another. Preference is given to effecting the adhesive bond close to the opening of the cavity into which the film material has been thermoformed in step c). The adhesive bonds are more preferably along a circumferential seal seam. This seal seam is realizable by a number of different procedures. However, preference is given to those processes in which the adhesive bond is effected by the action of adhesives and/or solvents and/or pressing or squeezing forces. However, particular preference is given to those processes according to the invention in which the molding is adhesively bonded to this first film material by an adhesive bond and/or a heat seal before, simultaneously with or after the thermoforming of the first film material in step c). In the case of heat-sealing too, particular preference is given to a circumferential seal seam, i.e. a continuous seal seam. A number of different tools and processes are available to the person skilled in the art for the heat-sealing of molding and film material.

In a first preferred embodiment, the heat-sealing is effected by the action of heated sealing tools.

In a second preferred embodiment, the heat-sealing is effected by the action of a laser beam.

In a third preferred embodiment, the heat-sealing is effected by the action of hot air.

In step d), of the process according to the invention, a washing- or cleaning-active substance is introduced onto the film material in the cavity. Suitable washing- or cleaning-active substances are solids and also liquids. The washing- or cleaning-active substance can be introduced onto the film material in the cavity by all metering processes known to those skilled in the art.

In a first preferred embodiment, prefabricated moldings, for example castings, tablets or extrudates, are placed onto the film material in the cavity in step d). When the molding used in step a) is a depression tablet or a ring tablet, the process end product of this preferred process variant corresponds to a core tablet or a ring-core tablet (“bullseye tablet”), in which the cavity of the tablet used in step a) is filled with a casting, a further tablet or an extrudate, the tablet and the introduced core being separated from one another by the film material thermoformed into the cavity in step c).

The washing- or cleaning-active substance introduced in step d) preferably has a density above 1.0 g/cm³, preferentially above 1.1 g/cm³, more preferably above 1.2 g/cm³, even more preferably above 1.3 g/cm³ and in particular above 1.4 g/cm³. The volume ratio of the molding provided in step a) to the substance volume introduced into the cavity in step d) is preferably between 1:1 and 20:1 and in particular between 3:1 and 15:1.

In the context of the present application, particular preference is given in particular to those processes in which a free-flowing washing- or cleaning-active substance is introduced in step d). These solid or liquid free-flowing substances or substance mixtures are preferably poured onto the film material in the cavity. The free-flowing substances used are preferably liquid(s) and/or gel(s) and/or powder and/or granule(s) and/or extrudate(s) and/or compactate(s).

When the solid free-flowing substances or substance mixtures used are particulate, for example powder, granules or extrudates, these particulate substances or substance mixtures have a mean particle size below 5000 μm, preferably less than 3000 μm, preferentially less than 1000 μm, even more preferably between 50 and 1000 μm and in particular between 100 and 800 μm.

In a further preferred embodiment, the free-flowing washing- or cleaning-active substance is a liquid. In the context of this application, liquid refers to substances or substance mixtures in their liquid state of matter. The term “liquid” accordingly encompasses not only liquid pure substances but also solutions, suspensions, emulsions or melts. Preference is given to using those substances or substance mixtures which are present in the liquid state of matter at 20° C. As a preferred constituent, the liquids comprise at least one substance from the group of the nonionic surfactants and/or the polymers and/or the organic solvents. The liquid may in turn have a plurality of phases.

The free-flowing washing- or cleaning-active substances used may also be molten substances or substance mixtures.

Preference is therefore in particular given to those processes according to the invention for producing a dosage unit for washing or cleaning compositions, comprising the steps of
a) providing a molding having at least one cavity;
a′) optionally partly filling the cavity with a washing- or cleaning-active composition, preferably a solid washing- or cleaning-active composition;
b) placing a first film material onto the molding surface over the opening of the cavity;
c) thermoforming the first film material into the cavity;
d) introducing a second washing- or cleaning-active substance, preferably a liquid washing- or cleaning-active substance, onto the film material in the cavity.

In step d), the cavity is preferably filled with a liquid. This liquid-filled cavity is then preferably sealed. In a particularly preferred embodiment, the sealing additionally encloses a gas or gas mixture in the cavity as well as the liquid. This gas or gas mixture may, for example, be an inert gas (e.g. argon or nitrogen), a reactive gas such as carbon dioxide, but, for example, also natural ambient air. Processes according to the invention in which the cavity is filled with a liquid in step d) and then sealed with inclusion of a gas bubble are particularly preferred. The volume of the gas bubble is preferably between 1 and 25% by volume, preferentially between 2 and 20% by volume and in particular between 4 and 10% by volume of the volume of the sealed cavity.

In a further preferred embodiment, the moldings provided in step a) have an envelope of a water-soluble or water-dispersible material, preferably an envelope of a water-soluble or water-dispersible film material, especially preferably of a polymer-based water-soluble or water-dispersible film material. Particularly preferred film materials are the materials described above from the group (optionally acetalized) polyvinyl alcohol (PVAL), polyvinylpyrrolidone, polyethylene oxide, gelatin, cellulose, and derivatives thereof and mixtures thereof. This envelope may enclose the molding fully or only partly. Particular preference is given to processes in which the molding in step a) is surrounded partly by a water-soluble or water-dispersible film material. Such a partial envelope can be realized, for example, by shaping a first water-soluble or water-dispersible film material, for example by thermoforming, to form a receiving chamber, and introducing the molding in step a) into this resulting receiving chamber. Alternatively, the water-soluble or water-dispersible receiving chamber can also be produced by injection-molding a water-soluble or water-dispersible material. Once the molding has been introduced into this receiving chamber in step a), the remaining steps of the process according to the invention are effected as described above, with the difference that, in this process variant, the possibility exists of adhesively bonding the envelope material of the molding from step a) to the first or the second preferably water-soluble film material from steps b) or e) in the course of the process, and in this way of achieving full enveloping of the washing- or cleaning-active substances provided in step a), a′) and d). The resulting process end product is notable not only for the separation of the active substances introduced in step a) and a′) and d), but also enables the formulation of readily soluble and hence highly active substances in powder form or in the form of liquid compositions in a prefabricated dosage unit.

Preference is thus further given to a process for producing a dosage unit for washing or cleaning compositions, comprising the steps of
a) providing a molding in a water-soluble or water-dispersible receiving chamber, the molding having at least one cavity;
a′) optionally partly filling the cavity with a washing- or cleaning-active composition, preferably a solid washing- or cleaning-active composition;
b) placing a first film material onto the molding surface over the opening of the cavity;
c) thermoforming the first film material into the cavity;
d) introducing a second washing- or cleaning-active substance, preferably a liquid washing- or cleaning-active substance, onto the film material in the cavity.

The water-soluble or water-dispersible receiving chamber is preferably adhesively bonded to the first film material from step b) in a further process step. The adhesive bond is preferably effected after the thermoforming of the first film material in step c), but can with preference also be effected after steps b) or d).

As mentioned at the outset, the cavity may be a depression or an aperture. With particular preference, the latter process variant is carried out with a molding which has an aperture as the cavity. The process product of this process variant is then a ring-core tablet (“bullseye tablet”), whose aperture is sealed at both sides by means of a water-soluble or water-dispersible material, the aperture itself being divided into two separate chambers which preferably have a different filling by a further water-soluble or water-dispersible material which may be identical to the aforementioned water-soluble or water-dispersible material but may also differ from this material.

The present application therefore further provides a process for producing a dosage unit for washing or cleaning compositions, comprising the steps of
a) providing a molding in a water-soluble or water-dispersible receiving chamber, the molding having at least one aperture;
a′) partly filling the aperture with a first washing- or cleaning-active composition, preferably a solid washing- or cleaning-active composition;
b) placing a first film material onto the molding surface over the opening of the aperture;
c) thermoforming the first film material into the aperture;
d) introducing a second washing- or cleaning-active substance, preferably a liquid washing- or cleaning-active substance, onto the film material in the cavity.

In the above-described process, preference is given to sealing the cavity opening in a further step e) after step d). In a preferred process variant, this sealing is effected by placing a second film material onto the cavity opening and then heat-sealing and/or ultrasound-sealing and/or high-frequency-sealing. This second film material may be the same film material or a different film material from the first film material used in step b). The second film material may differ from the first film material, for example, by its thickness and/or its composition. Of course, the second film material can also be sealed over the cavity opening by adhesive-bonding the second film material to the first film material or to the molding. In addition to adhesives known to those skilled in the art, suitable media for the sealing of the cavity opening by adhesive bonding are in particular solvents, more preferably water or aqueous solutions.

The sealed cavity preferably has an elevated pressure. Such a curvature can be achieved, for example, by addition of gas-releasing constituents to the washing- or cleaning-active substances introduced in step d). As a result of the gas release after sealing of the cavity in step e), the film material used for the sealing bulges and forms a visually appealing, convex curve.

It is preferred that the heat sealing and/or ultrasound sealing and/or high-frequency sealing and/or the adhesive bonding adhesively bonds the molding to the first film material and/or to the second film material.

Preference is thus further given in accordance with the invention to a process for producing a dosage unit for washing or cleaning compositions, comprising the steps of
a) providing a molding having at least one cavity;
a′) optionally partly filling the cavity with a washing- or cleaning-active composition, preferably a solid washing- or cleaning-active composition;
b) placing a first film material onto the molding surface over the opening of the cavity;
c) thermoforming the first film material into the cavity;
d) introducing a second washing- or cleaning-active substance, preferably a liquid washing- or cleaning-active substance, onto the film material in the cavity;
e) sealing the cavity filled in step d), preferably by applying a second film material and adhesively bonding the second film material to the molding from step a) and/or the first film material from step b).

Preference is thus further given to a process according to the invention for preparing a dosage unit for washing or cleaning compositions, comprising the steps of
a) providing a molding in a water-soluble or water-dispersible receiving chamber; the molding having at least one cavity;
a′) optionally partly filling the cavity with a washing- or cleaning-active composition, preferably a solid washing- or cleaning-active composition;
b) placing a first film material onto the molding surface over the opening of the cavity;
c) thermoforming the first film material into the cavity;
d) introducing a second washing- or cleaning-active substance, preferably a liquid washing- or cleaning-active substance, onto the film material in the cavity;
e) sealing the cavity filled in step d), preferably by applying a second film material and adhesively bonding the second film material to the molding from step a) and/or the first film material from step b);
   the water-soluble or water-dispersible receiving chamber being adhesively bonded to the first film material from step b) and/or the second film material from step e) in a further process step. The adhesive bond is preferably effected together with the sealing of the cavity filled in step d) in step e).

This application thus further provides a molding having an aperture (ring-core tablet or “bullseye tablet”) whose aperture has been sealed at both sides by means of a water-soluble or water-dispersible material, the aperture itself being divided into two separate chambers which preferably have a different filling by a further water-soluble or water-dispersible material. Particular preference is given to those moldings in which one of the chambers contains a solid washing- or cleaning-active substance, more preferably a solid washing- or cleaning-active substance in the form of a powder, granule or extrudate, while the second chamber contains a liquid washing- or cleaning-active substance. The water-soluble or water-dispersible materials which seal the aperture at both sides or divide the aperture into two separate chambers may be identical but may also be different from one another.

The volume of the chambers present in the aperture is in each case preferably between 0.5 and 15 ml, preferably between 0.5 and 12 ml, more preferably between 0.5 and 8 ml and in particular between 0.5 and 6 ml. The volume ratio of the chambers relative to one another is preferably between 10:1 and 1:10, preferentially between 8:1 and 1:8, more preferably between 6:1 and 1:6 and in particular between 4:1 and 1:4.

The above-described moldings with filled aperture enable the combined formulation of solid and liquid washing- and cleaning-active substances with use of minimal amounts of packaging materials. As a result of the use of water-soluble or water-dispersible packaging materials, these compositions are additionally suitable for direct dosage into the detergent drawer or the interior of a machine dishwasher or washing machine. The inventive moldings of this specific embodiment feature at least three phases (molding, first washing- or cleaning-active substance in chamber 1, second washing- or cleaning-active substance in chamber 2) and hence enable the visualization of complex active ingredient combinations (for example “2in1” or “3in1” products) for machine dishwashing or combination products of textile detergent and care additive such as a fabric softener, a dye transfer inhibitor or a crease preventative.

After the process according to the invention, the process end products are preferably isolated and finished. When the first or second film material used is, for example, a film web which is processed to give more than one of the inventive dosage units, this film material is cut to shape in the course of the process or after it has ended. Particular preference is given to processes according to the invention, characterized in that the first or second film material, in the course of the process, preferably after a sealing step, is cut through by a mechanical process and/or a thermal process to form a cut line, the cut line preferably running in a circuit on the surface of the molding.

The process according to the invention can also be followed by packaging of the process end products into flow-packs, block-bottom bags or cardboard packs.

In the process according to the invention, a film material, preferably a water-soluble or water-dispersible film material, is thermoformed into the cavities of washing or cleaning composition moldings to form a receiving chamber. The present application therefore further provides dosage units for washing or cleaning compositions, comprising a molding having at least one cavity, a film material thermoformed into the cavity to form a receiving chamber, and a washing- or cleaning-active substance present on the film material in the cavity. As a result of the thermoforming process, the film material closely fits the inner walls of the cavity. Compared to alternative processes, for example impressing or inlaying of a film material, this process is notable for optimized utilization of space.

As described at the outset, the molding is preferably a tablet, a compactate, an extrudate, an injection molding or a casting. With regard to the preferred production processes of this molding and its preferred three-dimensional shapes, reference is made at this point to the remarks in the description above to avoid repetition.

Preference is given in accordance with the invention to those dosage units which have, as a cavity, a depression or an aperture. The volume of the cavity is preferably between 0.1 and 20 ml, preferably between 0.2 and 15 ml, more preferably between 1 and 10 ml and in particular between 2 and 7 ml.

In addition to a molding, the inventive dosage units also comprise a receiving depression which has been formed from a preferably water-soluble or water-dispersible film material and filled with washing- or cleaning-active ingredients. In the case of a simple monophasic molding, the dosage unit thus has two separate phases. These separate phases enable, for example, the separation of incompatible ingredients or the combined dosage of washing or cleaning compositions with different states of matter or supply forms.

In a particularly preferred embodiment of the inventive compositions, the dosage unit is characterized in that the receiving chamber formed from the thermoformed film material is filled with a free-flowing, preferably a liquid washing- or cleaning-active substance, more preferably with one or more active substance(s) from the group of the nonionic surfactants and/or the polymers and/or the organic solvents.

The free-flowing washing- or cleaning-active substances may be solid or liquid. The free-flowing substances used are preferably liquid(s) and/or gel(s) and/or powder and/or granule(s) and/or extrudate(s) and/or compactate(s).

In a further preferred embodiment, the free-flowing washing- or cleaning-active substance is a liquid. In the context of this application, liquid refers to substances or substance mixtures in their liquid state of matter. The term “liquid” accordingly encompasses not only liquid pure substances but also solutions, suspensions, emulsions or melts. Preference is given to using those substances or substance mixtures which are present in the liquid state of matter at 20° C. As a preferred constituent, the liquids comprise at least one substance from the group of the nonionic surfactants and/or the polymers and/or the organic solvents.

The number of these phases of inventive dosage units can be increased by increasing the number of phases of the molding and/or the number of phases introduced into the cavity.

In a preferred embodiment, the molding therefore has two, three, four or more phases. In a further preferred embodiment, the washing- or cleaning-active material introduced into the cavity has two, three, four or more phases. For example, several different washing- or cleaning-active substances or substance mixtures can be introduced into the receiving chamber formed from the thermoformed film material. One example of such a preferred embodiment is an inventive dosage unit in which the receiving chamber formed from the thermoformed film material is filled with a biphasic or multiphasic liquid phase. Alternatively, a multiphase filling of this receiving chamber can, for example, also be realized by introducing two or more of the abovementioned free-flowing, solid washing- or cleaning-active substances in layers into the receiving chamber.

Particular preference is given to a dosage unit, characterized in that the cavity is additionally filled partly with a washing- or cleaning-active substance, preferably a substance from the group of builders, enzymes, bleaches, bleach activators, bleach catalysts, silver protectants or glass corrosion inhibitors, which is not present in the receiving chamber formed from the thermoformed film material.

Particular preference is given to an embodiment of the inventive dosage unit in which the cavity below the thermoformed film material is filled partly with a washing- or cleaning-active substance, preferably a solid washing- or cleaning-active substance. The resulting dosage unit then comprises a monophasic or multiphasic molding with a cavity, a washing- or cleaning-active substance introduced into the cavity, which only partly fills the cavity, and a receiving chamber formed from film material which has been thermoformed into the partly filled cavity, filled with a further washing- or cleaning-active substance. When the cavity is a depression, the washing- or cleaning-active substance introduced into the cavity is enclosed between the bottom of the depression and the receiving chamber formed from the thermoformed film material, and, provided that the filled receiving chamber is not at least partly transparent, is generally not visible from outside. When the cavity, in contrast, is an aperture having two opposite openings, the washing- or cleaning-active substance introduced into the cavity is visible through one of the openings, and the washing- or cleaning-active substance introduced into the receiving chamber formed from thermoformed film material through the other opening.

It is preferred that the washing- or cleaning-active substances which are introduced into the cavity of the molding outside the receiving chamber formed from thermoformed film material are selected from the group of the builders, enzymes, bleaches, bleach activators, bleach catalysts, silver protectants and glass corrosion inhibitors. Particular preference is given to introducing bleaches, especially peroxygen compounds such as percarbonates or perborates, bleach activators or silver protectants. These ingredients are preferably introduced into the cavity as a constituent of solid washing- or cleaning-active formulations between steps a) and b). These ingredients are described more precisely in the text below. To avoid repetitions, reference is made at this point to the remarks there.

In order to prevent the washing- or cleaning-active substances introduced into the receiving chamber formed from the thermoformed film material, especially the castable washing- or cleaning-active substances, from falling out of this receiving chamber, these substances are preferably fixed in the receiving chamber. This fixing can be effected, for example, by adhesion promoters. However, preference is given to an inventive dosage unit in which the receiving chamber which has been formed from the thermoformed film material and filled with the washing- or cleaning-active substance is sealed. Suitable sealing materials include, for example, melts of organic polymers or sugar melts. However, the receiving chamber which has been formed from the thermoformed film material and filled with the washing- or cleaning-active substance is preferably sealed with a further film material. As before, this film material is preferably a water-soluble or water-dispersible film material. In moldings which have an aperture as the cavity, both opening surfaces of the aperture are preferably sealed. The sealing material can partly cover the molding surface, for example in the case of the controlled sealing of individual cavity openings with a water-soluble or water-dispersible film material. However, the sealing material can also be used to entirely envelop the molding.

Particular preference is therefore given to inventive dosage units comprising a molding having at least one cavity, a film material thermoformed into the cavity to form a receiving chamber and a washing- or cleaning-active substance disposed on the film material in the cavity, the molding additionally having an envelope of a water-soluble or water-dispersible material. Such a water-soluble or water-dispersible envelope may, for example, comprise a thermoformed or injection-molded package.

In a further preferred embodiment, the molding is adhesively bonded to the film material thermoformed into the cavity and/or to the further film material used to seal the mould formed from the thermoformed film material by means of heat sealing and/or ultrasound sealing and/or high-frequency sealing.

Unlike in the case of conventional multiphasic washing or cleaning compositions, for example the depression tablets customary on the market with a compressed or cast core, the ingredients of the inventive washing or cleaning composition molding are separated spatially from the ingredients present in the receiving chamber formed from the film material. The resulting dosage unit is thus notable not only for the advantageous multiphasic product appearance but also for increased product and storage stability.

The inventive washing or cleaning compositions can be used not only for textile cleaning but also for cleaning hard surfaces or dishware.

In addition to the aforementioned washing- or cleaning-active substances, the washing or cleaning compositions produced in accordance with the invention preferably comprise further washing- and cleaning-active substances, especially washing- and cleaning-active substances from the group of the bleaches, bleach activators, builders, surfactants, enzymes, polymers, disintegration assistants, electrolytes, pH modifiers, fragrances, perfume carriers, dyes, hydrotropes, foam inhibitors, corrosion inhibitors and glass corrosion inhibitors. These preferred ingredients are described in detail below.

Builders

In the context of the present application, the builders include especially the zeolites, silicates, carbonates, organic cobuilders and, where there are no ecological objections to their use, also the phosphates.

Suitable crystalline, sheet-type sodium silicates have the general formula NaMSiₓO₂ₓ₊₁.H₂O where M is sodium or hydrogen, x is a number from 1.9 to 4, y is a number from 0 to 20, and preferred values for x are 2, 3 or 4. Preferred crystalline sheet silicates of the formula specified are those in which M is sodium and x assumes the values of 2 or 3. In particular, preference is given to both β- and also δ-sodium disilicates Na₂Si₂O₅.yH₂O.

It is also possible to use amorphous sodium silicates having an Na₂O:SiO₂ modulus of from 1:2 to 1:3.3, preferably from 1:2 to 1:2.8 and in particular from 1:2 to 1:2.6, which have retarded dissolution and secondary washing properties. The retardation of dissolution relative to conventional amorphous sodium silicates may have been brought about in a variety of ways, for example by surface treatment, compounding, compacting or by overdrying. In the context of this invention, the term “amorphous” also includes “X-ray-amorphous”. This means that, in X-ray diffraction experiments, the silicates do not afford any sharp X-ray reflections typical of crystalline substances, but rather yield at best one or more maxima of the scattered X-radiation, which have a width of several degree units of the diffraction angle. However, it may quite possibly lead to even particularly good builder properties if the silicate particles in electron diffraction experiments yield vague or even sharp diffraction maxima. This is to be interpreted such that the products have microcrystalline regions with a size of from 10 to several hundred nm, preference being given to values up to a maximum of 50 nm and in particular up to a maximum of 20 nm. Such X-ray-amorphous silicates likewise have retarded dissolution compared with conventional waterglasses. Special preference is given to compacted amorphous silicates, compounded amorphous silicates and overdried X-ray-amorphous silicates.

In the context of the present invention, it is preferred that these silicate(s), preferably alkali metal silicates, more preferably crystalline or amorphous alkali metal disilicates, are present in washing or cleaning compositions in amounts of from 10 to 60% by weight, preferably from 15 to 50% by weight and in particular from 20 to 40% by weight, based in each case on the weight of the washing or cleaning composition.

When the silicates are used as a constituent of machine dishwasher detergents, these compositions preferably comprise at least one crystalline sheet-type silicate of the general formula NaMSiₓO₂ₓ₊₁.yH₂O where M is sodium or hydrogen, x is a number from 1.9 to 22, preferably from 1.9 to 4, and y is a number from 0 to 33. The crystalline sheet-type silicates of the formula NaMSiₓO₂ₓ₊₁.yH₂O are sold, for example, by Clariant GmbH (Germany) under the trade name Na-SKS, for example Na-SKS-1 (Na₂Si₂₂O₄₅.xH₂O, kenyaite), Na-SKS-2 (Na₂Si₁₄O₂₉.xH₂O, magadiite), Na-SKS-3 (Na₂Si₈O₁₇.xH₂O) or Na-SKS-4 (Na₂Si₄O₉.xH₂O, makatite).

Particularly suitable for the purposes of the present invention are crystalline sheet silicates of the formula (I) in which x is 2. Among these, suitable in particular are Na-SKS-5 (α-Na₂Si₂O₅), Na-SKS-7 (β-Na₂Si₂O₅, natrosilite), Na-SKS-9 (NaHSi₂O₅.H₂O), Na-SKS-10 (NaHSi₂O₅.3H₂O, kanemite), Na-SKS-11 (t-Na₂Si₂O₅) and Na-SKS-13 (NaHSi₂O₅), but in particular Na-SKS-6 (δ-Na₂Si₂O₅).

When the silicates are used as a constituent of machine dishwasher detergents, these compositions in the context of the present application comprise a proportion by weight of the crystalline sheet-type silicate of the formula NaMSiₓO₂ₓ₊₁.yH₂O of from 0.1 to 20% by weight, preferably from 0.2 to 15% by weight and in particular from 0.4 to 10% by weight, based in each case on the total weight of these compositions. It is particularly preferred especially when such machine dishwasher detergents have a total silicate content below 7% by weight, preferably below 6% by weight, preferentially below 5% by weight, more preferably below 4% by weight, even more preferably below 3% by weight and in particular below 2.5% by weight, this silicate, based on the total weight of the silicate present, being silicate of the general formula NaMSiₓO₂ₓ₊₁.yH₂O preferably to an extent of at least 70% by weight, preferentially to an extent of at least 80% by weight and in particular to an extent of at least 90% by weight.

The finely crystalline, synthetic, bound water-containing zeolite used is preferably zeolite A and/or P. The zeolite P is more preferably Zeolite MAP® (commercial product from Crosfield). Also suitable, however, are zeolite X, and mixtures of A, X and/or P. Also commercially available and usable with preference in accordance with the present invention is, for example, a cocrystal of zeolite X and zeolite A (approx. 80% by weight of zeolite X), which is sold by CONDEA Augusta S.p.A. under the trade name VEGOBOND AX® and can be described by the formula
nNa₂O.(1−n)K₂O.Al₂O₃.(2−2.5)SiO₂.(3.5−5.5)H₂O.
The zeolite may be used either as a builder in a granular compound or in a kind of “powdering” of the entire mixture to be compacted, and both ways of incorporating the zeolite into the premixture are typically utilized. Suitable zeolites have an average particle size of less than 10 μm (volume distribution; measurement method: Coulter Counter) and preferably contain from 18 to 22% by weight, in particular from 20 to 22% by weight, of bound water.

It is of course also possible to use the commonly known phosphates as builder substances, as long as such a use is not to be avoided for ecological reasons. This is especially true for the use of inventive compositions as machine dishwasher detergents, which is particularly preferred in the context of the present application. Among the multitude of commercially available phosphates, the alkali metal phosphates, with particular preference for pentasodium triphosphate or pentapotassium triphosphate (sodium tripolyphosphate or potassium tripolyphosphate), have the greatest significance in the washing and cleaning products industry.

Alkali metal phosphates is the collective term for the alkali metal (especially sodium and potassium) salts of the various phosphoric acids, for which a distinction may be drawn between metaphosphoric acids (HPO₃)ₙ and orthophosphoric acid H₃PO₄, in addition to higher molecular weight representatives. The phosphates combine a number of advantages: they act as alkali carriers, prevent limescale deposits on machine components and lime encrustations in fabrics, and additionally contribute to the cleaning performance.

Suitable phosphates are, for example, sodium dihydrogenphosphate, NaH₂PO₄, in the form of the dihydrate (density 1.91 gcm⁻³, melting point 600) or in the form of the monohydrate (density 2.04 gcm⁻³), disodium hydrogen phosphate (secondary sodium phosphate), Na₂HPO₄, which is in anhydrous form or can be used with 2 mol of water (density 2.066 gcm⁻³, loss of water at 95°), 7 mol of water (density 1.68 gcm⁻³, melting point 480 with loss of 5H₂O) and 12 mol of water (density 1.52 gcm⁻³, melting point 350 with loss of 5H₂O), but in particular trisodium phosphate (tertiary sodium phosphate) Na₃PO₄, which can be used as the dodecahydrate, as the decahydrate (corresponding to 19-20% P₂O₅) and in anhydrous form (corresponding to 39-40% P₂O₅).

A further preferred phosphate is tripotassium phosphate (tertiary or tribasic potassium phosphate), K₃PO₄. Preference is further given to tetrasodium diphosphate (sodium pyrophosphate), Na₄P₂O₇, which exists in anhydrous form (density 2.534 gcm⁻³, melting point 988°, 880° also reported) and as the decahydrate (density 1.815-1.836 gcm⁻³, melting point 94° with loss of water), and also the corresponding potassium salt, potassium diphosphate (potassium pyrophosphate), K₄P₂O₇.

The industrially important pentasodium triphosphate, Na₅P₃O₁₀ (sodium tripolyphosphate), is a nonhygroscopic, white, water-soluble salt which is anhydrous or crystallizes with 6H₂O and has the general formula NaO—[P(O)(ONa)—O]ₙ—Na where n=3. The corresponding potassium salt, pentapotassium triphosphate, K₅P₃O₁₀ (potassium tripolyphosphate), is available commercially, for example, in the form of a 50% by weight solution (>23% P₂O₅, 25% K₂O). The potassium polyphosphates find wide use in the washing and cleaning products industry. There also exist sodium potassium tripolyphosphates which can likewise be used in the context of the present invention. They are formed, for example, when sodium trimetaphosphate is hydrolyzed with KOH:
(NaPO₃)₃+2KOH→Na₃K₂P₃O₁₀+H₂O

They can be used in accordance with the invention in precisely the same way as sodium tripolyphosphate, potassium tripolyphosphate or mixtures of the two; mixtures of sodium tripolyphosphate and sodium potassium tripolyphosphate or mixtures of potassium tripolyphosphate and sodium potassium tripolyphosphate or mixtures of sodium tripolyphosphate and potassium tripolyphosphate and sodium potassium tripolyphosphate can also be used in accordance with the invention.

When phosphates are used as washing- or cleaning-active substances in washing or cleaning compositions in the context of the present application, preferred compositions comprise these phosphate(s), preferably alkali metal phosphate(s), more preferably pentasodium triphosphate or pentapotassium triphosphate (sodium tripolyphosphate or potassium tripolyphosphate), in amounts of from 5 to 80% by weight, preferably from 15 to 75% by weight and in particular from 20 to 70% by weight, based in each case on the weight of the washing or cleaning composition.

It is especially preferred to use potassium tripolyphosphate and sodium tripolyphosphate in a weight ratio of more than 1:1, preferably more than 2:1, preferentially more than 5:1, more preferably more than 10:1 and especially more than 20:1. It is particularly preferred to use exclusively potassium tripolyphosphate without additions of other phosphates.

Further builders are the alkali carriers. Alkali carriers include, for example, alkali metal hydroxides, alkali metal carbonates, alkali metal hydrogencarbonates, alkali metal sesquicarbonates, the aforementioned alkali metal silicates, alkali metal metasilicates and mixtures of the aforementioned substances, preference being given in the context of this invention to using the alkali metal carbonates, especially sodium carbonate, sodium hydrogencarbonate or sodium sesquicarbonate. Particular preference is given to a builder system comprising a mixture of tripolyphosphate and sodium carbonate. Particular preference is likewise given to a builder system comprising a mixture of tripolyphosphate and sodium carbonate and sodium disilicate. Owing to their low chemical compatibility with the remaining ingredients of washing or cleaning compositions in comparison with other builder substances, the alkali metal hydroxides are preferably used only in small amounts, preferably in amounts below 10% by weight, preferentially below 6% by weight, more preferably below 4% by weight and in particular below 2% by weight, based in each case on the total weight of the washing or cleaning composition. Particular preference is given to compositions which, based on their total weight, contain less than 0.5% by weight of and in particular no alkali metal hydroxides.

Particular preference is given to the use of carbonate(s) and/or hydrogencarbonate(s), preferably alkali metal carbonates, more preferably sodium carbonate, in amounts of from 2 to 50% by weight, preferably from 5 to 40% by weight and in particular from 7.5 to 30% by weight, based in each case on the weight of the washing or cleaning composition. Particular preference is given to compositions which, based on the weight of the washing or cleaning composition (i.e. the total weight of the combination product without packaging), contain less than 20% by weight, preferably less than 17% by weight, preferentially less than 13% by weight and in particular less than 9% by weight of carbonate(s) and/or hydrogencarbonate(s), preferably alkali metal carbonates, more preferably sodium carbonate.

Organic cobuilders include in particular polycarboxylates/polycarboxylic acids, polymeric polycarboxylates, aspartic acid, polyacetals, dextrins, further organic cobuilders (see below) and phosphonates. These substance classes are described below.

Organic builder substances which can be used are, for example, the polycarboxylic acids usable in the form of their sodium salts, polycarboxylic acids referring to those carboxylic acids which bear more than one acid function. Examples of these are citric acid, adipic acid, succinic acid, glutaric acid, malic acid, tartaric acid, maleic acid, fumaric acid, sugar acids, aminocarboxylic acids, nitrilotriacetic acid (NTA), as long as such a use is not objectionable on ecological grounds, and mixtures thereof. Preferred salts are the salts of the polycarboxylic acids such as citric acid, adipic acid, succinic acid, glutaric acid, tartaric acid, sugar acids and mixtures thereof.

The acids themselves may also be used. In addition to their builder action, the acids typically also have the property of an acidifying component and thus also serve to set a lower and milder pH of washing and cleaning compositions. In this connection, particular mention should be made of citric acid, succinic acid, glutaric acid, adipic acid, gluconic acid and any mixtures thereof.

Also suitable as builders are polymeric polycarboxylates; these are, for example, the alkali metal salts of polyacrylic acid or of polymethacrylic acid, for example those having a relative molecular mass of from 500 to 70 000 g/mol.

In the context of this document, the molar masses specified for polymeric polycarboxylates are weight-average molar masses M_{W} of the particular acid form, which has always been determined by means of gel-permeation chromatography (GPC) using a UV detector. The measurement was against an external polyacrylic acid standard which, owing to its structural similarity to the polymers under investigation, provides realistic molecular weight values. These figures deviate considerably from the molecular weight data when polystyrenesulfonic acids are used as the standard. The molar masses measured against polystyrenesulfonic acids are generally distinctly higher than the molar masses specified in this document.

Suitable polymers are in particular polyacrylates which preferably have a molecular mass of from 2000 to 20 000 g/mol. Owing to their superior solubility, preference within this group may be given in turn to the short-chain polyacrylates which have molar masses of from 2000 to 10 000 g/mol and more preferably from 3000 to 5000 g/mol.

Also suitable are copolymeric polycarboxylates, especially those of acrylic acid with methacrylic acid and of acrylic acid or methacrylic acid with maleic acid. Copolymers which have been found to be particularly suitable are those of acrylic acid with maleic acid which contain from 50 to 90% by weight of acrylic acid and from 50 to 10% by weight of maleic acid. Their relative molecular mass, based on free acids, is generally from 2000 to 70 000 g/mol, preferably from 20 000 to 50 000 g/mol and in particular from 30 000 to 40 000 g/mol.

The (co)polymeric polycarboxylates can either be used in the form of powders or in the form of aqueous solutions. The (co)polymeric polycarboxylate content of the washing or cleaning compositions is preferably from 0.5 to 20% by weight, in particular from 3 to 10% by weight.

To improve the water solubility, the polymers may also contain allylsulfonic acids, for example allyloxybenzenesulfonic acid and methallylsulfonic acid, as monomers.

Also especially preferred are biodegradable polymers composed of more than two different monomer units, for example those which contain, as monomers, salts of acrylic acid and of maleic acid, and vinyl alcohol or vinyl alcohol derivatives, or those which contain, as monomers, salts of acrylic acid and of 2-alkylallylsulfonic acid, and sugar derivatives.

Further preferred copolymers are those which preferably have, as monomers, acrolein and acrylic acid/acrylic acid salts or acrolein and vinyl acetate.

Further preferred builder substances which should likewise be mentioned are polymeric aminodicarboxylic acids, salts thereof or precursor substances thereof. Particular preference is given to polyaspartic acids or salts thereof.

Further suitable builder substances are polyacetals which can be obtained by reacting dialdehydes with polyolcarboxylic acids which have from 5 to 7 carbon atoms and at least 3 hydroxyl groups. Preferred polyacetals are obtained from dialdehydes such as glyoxal, glutaraldehyde, terephthalaldehyde, and mixtures thereof, and from polyolcarboxylic acids such as gluconic acid and/or glucoheptonic acid.

Further suitable organic builder substances are dextrins, for example oligomers or polymers of carbohydrates, which can be obtained by partial hydrolysis of starches. The hydrolysis can be carried out by customary, for example acid-catalyzed or enzyme-catalyzed, processes. The hydrolysis products preferably have average molar masses in the range from 400 to 500 000 g/mol. Preference is given to a polysaccharide having a dextrose equivalent (DE) in the range from 0.5 to 40, in particular from 2 to 30, where DE is a common measure of the reducing action of a polysaccharide compared to dextrose, which has a DE of 100. It is also possible to use maltodextrins with a DE between 3 and 20 and dry glucose syrups with a DE between 20 and 37, and also what are known as yellow dextrins and white dextrins having relatively high molar masses in the range from 2000 to 30 000 g/mol.

The oxidized derivatives of such dextrins are their reaction products with oxidizing agents which are capable of oxidizing at least one alcohol function of the saccharide ring to the carboxylic acid function.

Oxydisuccinates and other derivatives of disuccinates, preferably ethylenediaminedisuccinate, are also further suitable cobuilders. In this case, ethylenediamine-N,N′-disuccinate (EDDS) is preferably used in the form of its sodium or magnesium salts. Furthermore, in this connection, preference is also given to glyceryl disuccinates and glyceryl trisuccinates. Suitable use amounts in zeolite-containing and/or silicate-containing formulations are from 3 to 15% by weight.

Further organic cobuilders which can be used are, for example, acetylated hydroxycarboxylic acids or salts thereof, which may also be present in lactone form and which contain at least 4 carbon atoms and at least one hydroxyl group and a maximum of two acid groups.

In addition, it is possible to use all compounds which are capable of forming complexes with alkaline earth metal ions as builders.

Surfactants

The group of the surfactants includes not only the nonionic surfactants described at the outset but also the anionic, cationic and amphoteric surfactants.

The nonionic surfactants used in the context of the present application may be all nonionic surfactants known to those skilled in the art. Preference is given to alkoxylated, advantageously ethoxylated, in particular primary alcohols having preferably from 8 to 18 carbon atoms and on average from 1 to 12 mol of ethylene oxide (EO) per mole of alcohol in which the alcohol radical may be linear or preferably 2-methyl-branched, or may contain a mixture of linear and methyl-branched radicals, as are typically present in oxo alcohol radicals. However, especially preferred alcohol ethoxylates have linear radicals of alcohols of native origin having from 12 to 18 carbon atoms, for example of coconut, palm, tallow fat or oleyl alcohol, and on average from 2 to 8 EO per mole of alcohol. The preferred ethoxylated alcohols include, for example, C₁₂₋₁₄-alcohols having 3 EO or 4 EO, C₉₋₁₁-alcohol having 7 EO, C₁₃₋₁₅-alcohols having 3 EO, 5 EO, 7 EO or 8 EO, C₁₂₋₁₈-alcohols having 3 EO, 5 EO or 7 EO and mixtures thereof, such as mixtures of C₁₂₋₁₄-alcohol having 3 EO and C₁₂₋₁₈-alcohol having 5 EO. The degrees of ethoxylation specified are statistical average values which may be an integer or a fraction for a specific product. Preferred alcohol ethoxylates have a narrowed homolog distribution (narrow range ethoxylates, NRE). In addition to these nonionic surfactants, it is also possible to use fatty alcohols having more than 12 EO. Examples thereof are tallow fatty alcohol having 14 EO, 25 EO, 30 EO or 40 EO.

In addition, further nonionic surfactants which may be used are also alkyl glycosides of the general formula RO(G)ₓ in which R is a primary straight-chain or methyl-branched, in particular 2-methyl-branched, aliphatic radical having from 8 to 22, preferably from 12 to 18, carbon atoms and G is the symbol which is a glycose unit having 5 or 6 carbon atoms, preferably glucose. The degree of oligomerization x, which specifies the distribution of monoglycosides and oligoglycosides, is any number between 1 and 10; x is preferably from 1.2 to 1.4.

A further class of nonionic surfactants used with preference, which are used either as the sole nonionic surfactant or in combination with other nonionic surfactants, are alkoxylated, preferably ethoxylated or ethoxylated and propoxylated, fatty acid alkyl esters, preferably having from 1 to 4 carbon atoms in the alkyl chain.

Nonionic surfactants of the amine oxide type, for example N-cocoalkyl-N,N-dimethylamine oxide and N-tallowalkyl-N,N-dihydroxy-ethylamine oxide, and of the fatty acid alkanolamide type may also be suitable. The amount of these nonionic surfactants is preferably not more than that of the ethoxylated fatty alcohols, in particular not more than half thereof.

Further suitable surfactants are polyhydroxy fatty acid amides of the formula (V) 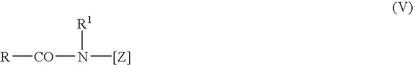
in which RCO is an aliphatic acyl radical having from 6 to 22 carbon atoms, R¹ is hydrogen, an alkyl or hydroxyalkyl radical having from 1 to 4 carbon atoms and [Z] is a linear or branched polyhydroxyalkyl radical having from 3 to 10 carbon atoms and from 3 to 10 hydroxyl groups. The polyhydroxy fatty acid amides are known substances which can typically be obtained by reductively aminating a reducing sugar with ammonia, an alkylamine or an alkanolamine, and subsequently acylating with a fatty acid, a fatty acid alkyl ester or a fatty acid chloride.

The group of polyhydroxy fatty acid amides also includes compounds of the formula 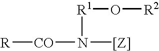
in which R is a linear or branched alkyl or alkenyl radical having from 7 to 12 carbon atoms, R¹ is a linear, branched or cyclic alkyl radical or an aryl radical having from 2 to 8 carbon atoms and R² is a linear, branched or cyclic alkyl radical or an aryl radical or an oxyalkyl radical having from 1 to 8 carbon atoms, preference being given to C₁₋₄-alkyl or phenyl radicals, and [Z] is a linear polyhydroxyalkyl radical whose alkyl chain is substituted by at least two hydroxyl groups, or alkoxylated, preferably ethoxylated or propoxylated, derivatives of this radical.

[Z] is preferably obtained by reductive amination of a reduced sugar, for example glucose, fructose, maltose, lactose, galactose, mannose or xylose. The N-alkoxy- or N-aryloxy-substituted compounds can be converted to the desired polyhydroxy fatty acid amides by reaction with fatty acid methyl esters in the presence of an alkoxide as catalyst.

The surfactants used with preference are low-foaming nonionic surfactants. With particular preference, the inventive cleaning compositions for machine dishwashing comprise nonionic surfactants, in particular nonionic surfactants from the group of the alkoxylated alcohols. The nonionic surfactants used are preferably alkoxylated, advantageously ethoxylated, in particular primary alcohols having preferably from 8 to 18 carbon atoms and on average from 1 to 12 mol of ethylene oxide (EO) per mole of alcohol in which the alcohol radical may be linear or preferably 2-methyl-branched, or may contain a mixture of linear and methyl-branched radicals, as are typically present in oxo alcohol radicals. However, especially preferred are alcohol ethoxylates having linear radicals of alcohols of native origin having from 12 to 18 carbon atoms, for example of coconut, palm, tallow fat or oleyl alcohol, and on average from 2 to 8 EO per mole of alcohol. The preferred ethoxylated alcohols include, for example, C₁₂₋₁₄-alcohols having 3 EO or 4 EO, C₉₋₁₁-alcohol having 7 EO, C₁₃₋₁₅-alcohols having 3 EO, 5 EO, 7 EO or 8 EO, C₁₂₋₁₈-alcohols having 3 EO, 5 EO or 7 EO and mixtures thereof, such as mixtures of C₁₂₋₁₄-alcohol having 3 EO and C₁₂₋₁₈-alcohol having 5 EO. The degrees of ethoxylation specified are statistical average values which may be an integer or a fraction for a specific product. Preferred alcohol ethoxylates have a narrowed homolog distribution (narrow range ethoxylates, NRE). In addition to these nonionic surfactants, it is also possible to use fatty alcohols having more than 12 EO. Examples thereof are tallow fatty alcohol having 14 EO, 25 EO, 30 EO or 40 EO.

With particular preference, also claimed are in particular machine dishwasher detergents which comprise, as surfactant(s), one or more tallow fat alcohols having 20 or 30 EO in combination with a silicone defoamer.

Nonionic surfactants from the group of the alkoxylated alcohols, more preferably from the group of the mixed alkoxylated alcohols and in particular from the group of the EO-AO-EO nonionic surfactants are used with particular preference in the context of the present application.

Special preference is given to nonionic surfactants which have a melting point above room temperature, particular preference being given to nonionic surfactant(s) having a melting point above 20° C., preferably above 25° C., more preferably between 25 and 60° C. and in particular between 26.6 and 43.3° C.

Suitable nonionic surfactants which have melting or softening points in the temperature range specified are, for example, low-foaming nonionic surfactants which may be solid or highly viscous at room temperature. When nonionic surfactants which have a high viscosity at room temperature are used, they preferably have a viscosity above 20 Pas, preferably above 35 Pas and in particular above 40 Pas. Nonionic surfactants which have a waxlike consistency at room temperature are also preferred.

Nonionic surfactants which are solid at room temperature and are to be used with preference stem from the groups of alkoxylated nonionic surfactants, in particular the ethoxylated primary alcohols and mixtures of these surfactants with structurally complex surfactants, such as polyoxypropylene/polyoxyethylene/polyoxypropylene (PO/EO/PO) surfactants. Such (PO/EO/PO) nonionic surfactants are additionally notable for good foam control.

In a preferred embodiment of the present invention, the nonionic surfactant with a melting point above room temperature is an ethoxylated nonionic surfactant which has resulted from the reaction of a monohydroxyalkanol or alkylphenol having from 6 to 20 carbon atoms with preferably at least 12 mol, more preferably at least 15 mol, in particular at least 20 mol, of ethylene oxide per mole of alcohol or alkylphenol.

A nonionic surfactant which is solid at room temperature and is to be used with particular preference is obtained from a straight-chain fatty alcohol having from 16 to 20 carbon atoms (C₁₆₋₂₀-alcohol), preferably a C₁₈-alcohol, and at least 12 mol, preferably at least 15 mol and in particular at least 20 mol, of ethylene oxide. Of these, the “narrow range ethoxylates” (see above) are particularly preferred.

Particular preference is therefore given to using ethoxylated nonionic surfactants which have been obtained from C₆₋₂₀-monohydroxyalkanols or C₆₋₂₀-alkylphenols or C₁₆₋₂₀-fatty alcohols and more than 12 mol, preferably more than 15 mol and in particular more than 20 mol of ethylene oxide per mole of alcohol.

The room temperature solid nonionic surfactant preferably additionally has propylene oxide units in the molecule. Preferably, such PO units make up up to 25% by weight, more preferably up to 20% by weight and in particular up to 15% by weight, of the total molar mass of the nonionic surfactant. Particularly preferred nonionic surfactants are ethoxylated monohydroxyalkanols or alkylphenols which additionally have polyoxyethylene-polyoxypropylene block copolymer units. The alcohol or alkylphenol moiety of such nonionic surfactant molecules preferably makes up more than 30% by weight, more preferably more than 50% by weight and in particular more than 70% by weight, of the total molar mass of such nonionic surfactants. Preferred compositions are characterized in that they comprise ethoxylated and propoxylated nonionic surfactants in which the propylene oxide units in the molecule make up up to 25% by weight, preferably up to 20% by weight and in particular up to 15% by weight, of the total molar mass of the nonionic surfactant.

Further nonionic surfactants which have melting points above room temperature and are to be used with particular preference contain from 40 to 70% of a polyoxypropylene/polyoxyethylene/polyoxypropylene block polymer blend which contains 75% by weight of an inverse block copolymer of polyoxyethylene and polyoxypropylene having 17 mol of ethylene oxide and 44 mol of propylene oxide, and 25% by weight of a block copolymer of polyoxyethylene and polyoxypropylene initiated with trimethylolpropane and containing 24 mol of ethylene oxide and 99 mol of propylene oxide per mole of trimethylolpropane.

Nonionic surfactants which can be used with particular preference are obtainable, for example, under the name Poly Tergent® SLF-18 from Olin Chemicals.

A further preferred inventive dishwasher detergent comprises nonionic surfactant(s) of the formula
R¹O[CH₂CH(CH₃)O]ₓ[CH₂CH₂O]_{y}CH₂CH(OH)R²
in which R¹ is a linear or branched aliphatic hydrocarbon radical having from 4 to 18 carbon atoms or mixtures thereof, R² is a linear or branched hydrocarbon radical having from 2 to 26 carbon atoms or mixtures thereof, and x is values between 0.5 and 1.5, and y is a value of at least 15.

Further nonionic surfactants which can be used with preference are the end group-capped poly(oxyalkylated)nonionic surfactants of the formula
R¹O[CH₂CH(R³)O]ₓ[CH₂]ₖCH(OH)[CH₂]ⱼOR²
in which R¹ and R² are linear or branched, saturated or unsaturated, aliphatic or aromatic hydrocarbon radicals having from 1 to 30 carbon atoms, R³ is H or a methyl, ethyl, n-propyl, isopropyl, n-butyl, 2-butyl or 2-methyl-2-butyl radical, x is a value between 1 and 30, k and j are values between 1 and 12, preferably between 1 and 5. When the value x is >2, each R³ in the above formula may be different. R¹ and R² are preferably linear or branched, saturated or unsaturated, aliphatic or aromatic hydrocarbon radicals having from 6 to 22 carbon atoms, particular preference being given to radicals having from 8 to 18 carbon atoms. For the R³ radical, particular preference is given to H, —CH₃ or —CH₂CH₃. Particularly preferred values for x are in the range from 1 to 20, in particular from 6 to 15.

As described above, each R³ in the above formula may be different if x is >2. This allows the alkylene oxide unit in the square brackets to be varied. When x is, for example, 3, the R³ radical may be selected so as to form ethylene oxide (R³═H) or propylene oxide (R³═CH₃) units which can be joined together in any sequence, for example (EO)(PO)(EO), (EO)(EO)(PO), (EO)(EO)(EO), (PO)(EO)(PO), (PO)(PO)(EO) and (PO)(PO)(PO). The value 3 for x has been selected here by way of example and it is entirely possible for it to be larger, the scope of variation increasing with increasing x values and embracing, for example, a large number of (EO) groups combined with a small number of (PO) groups, or vice versa.

Especially preferred end group-capped poly(oxyalkylated) alcohols of the above formula have values of k=1 and j=1, so that the above formula is simplified to
R¹O[CH₂CH(R³)O]ₓCH₂CH(OH)CH₂OR².
In the latter formula, R¹, R² and R³ are each as defined above and x is a number from 1 to 30, preferably from 1 to 20 and in particular from 6 to 18. Particular preference is given to surfactants in which the R¹ and R² radicals have from 9 to 14 carbon atoms, R³ is H and x assumes values of from 6 to 15.

If the latter statements are summarized, preference is given to inventive dishwasher detergents which comprise end group-capped poly(oxyalkylated)nonionic surfactants of the formula
R¹O[CH₂CH(R³)O]ₓ[CH₂]ₖCH(OH)[CH₂]ⱼOR²
in which R¹ and R² are linear or branched, saturated or unsaturated, aliphatic or aromatic hydrocarbon radicals having from 1 to 30 carbon atoms, R³ is H or a methyl, ethyl, n-propyl, isopropyl, n-butyl, 2-butyl or 2-methyl-2-butyl radical, x is values between 1 and 30, k and j are values between 1 and 12, preferably between 1 and 5, particular preference being given to surfactants of the
R¹O[CH₂CH(R³)O]ₓCH₂CH(OH)CH₂OR²
type in which x is from 1 to 30, preferably from 1 to 20 and in particular from 6 to 18.

Particularly preferred nonionic surfactants in the context of the present invention have been found to be low-foaming nonionic surfactants which have alternating ethylene oxide and alkylene oxide units. Among these, preference is given in turn to surfactants having EO-AO-EO-AO blocks, and in each case from one to ten EO and/or AO groups are bonded to one another before a block of the other groups in each case follows. Preference is given here to inventive machine dishwasher detergents which comprise, as nonionic surfactant(s), surfactants of the general formula 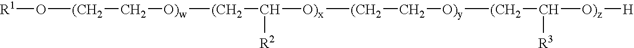
in which R¹ is a straight-chain or branched, saturated or mono- or polyunsaturated C₆₋₂₄-alkyl or -alkenyl radical; each R² or R³ group is independently selected from —CH₃; —CH₂CH₃, —CH₂CH₂—CH₃, CH(CH₃)₂ and the indices w, x, y, z are each independently integers from 1 to 6.

The preferred nonionic surfactants of the formula II can be prepared by known methods from the corresponding alcohols R¹—OH and ethylene oxide or alkylene oxide. The R¹ radical in the above formula II may vary depending on the origin of the alcohol. When native sources are utilized, the R¹ radical has an even number of carbon atoms and is generally unbranched, and preference is given to the linear radicals of alcohols of native origin having from 12 to 18 carbon atoms, for example from coconut, palm, tallow fat or oleyl alcohol. Alcohols obtainable from synthetic sources are, for example, the Guerbet alcohols or 2-methyl-branched or linear and methyl-branched radicals in a mixture, as are typically present in oxo alcohol radicals. Irrespective of the type of the alcohol used to prepare the nonionic surfactants present in accordance with the invention in the compositions, preference is given to inventive machine dishwasher detergents in which R¹ in formula VII is an alkyl radical having from 6 to 24, preferably from 8 to 20, more preferably from 9 to 15 and in particular from 9 to 11 carbon atoms.

The alkylene oxide unit which is present in the preferred nonionic surfactants in alternation to the ethylene oxide unit is, as well as propylene oxide, especially butylene oxide. However, further alkylene oxides in which R² and R³ are each independently selected from —CH₂CH₂—CH₃ and CH(CH₃)₂ are also suitable. Preferred machine dishwasher detergents are characterized in that R² and R³ are each a —CH₃ radical, w and x are each independently 3 or 4, and y and z are each independently 1 or 2.

In summary, for use in the inventive compositions, preference is given in particular to nonionic surfactants which have a C₉₋₁₅-alkyl radical having from 1 to 4 ethylene oxide units, followed by from 1 to 4 propylene oxide units, followed by from 1 to 4 ethylene oxide units, followed by from 1 to 4 propylene oxide units. In aqueous solution, these surfactants have the required low viscosity and can be used with particular preference in accordance with the invention.

Further nonionic surfactants usable with preference are the end group-capped poly(oxyalkylated)nonionic surfactants of the formula
R¹O[CH₂CH(R³)O]ₓR²
in which R¹ is linear or branched, saturated or unsaturated, aliphatic or aromatic hydrocarbon radicals having from 1 to 30 carbon atoms, R² is linear or branched, saturated or unsaturated, aliphatic or aromatic hydrocarbon radicals having from 1 to 30 carbon atoms and preferably having between 1 and 5 hydroxyl groups and are preferably further functionalized with an ether group, R³ is H or a methyl, ethyl, n-propyl, isopropyl, n-butyl, 2-butyl or 2-methyl-2-butyl radical, x is values between 1 and 40.

Preference is likewise given to machine dishwasher detergents which comprise nonionic surfactant(s) of the general formula
R¹O[CH₂CH(R³)O]ₓR²
in which R¹ is linear or branched, saturated or unsaturated, aliphatic or aromatic hydrocarbon radicals having from 1 to 30 carbon atoms, R² is linear or branched, saturated or unsaturated, aliphatic or aromatic hydrocarbon radicals having from 1 to 30 carbon atoms, which have preferably between 1 and 5 hydroxyl groups and are preferably further functionalized with an ether group, R³ is H or a methyl, ethyl, n-propyl, isopropyl, n-butyl, 2-butyl or 2-methyl-2-butyl radical, and x is values between 1 and 40.

In a particularly preferred embodiment of the present application, R³ in the aforementioned general formula is H. From the group of the resulting end group-capped poly(oxyalkylated)nonionic surfactants of the formula
R¹O[CH₂CH₂O]ₓR²,
preference is given in particular to those nonionic surfactants in which R¹ is linear or branched, saturated or unsaturated, aliphatic or aromatic hydrocarbon radicals having from 1 to 30 carbon atoms, preferably having from 4 to 20 carbon atoms, R² is linear or branched, saturated or unsaturated, aliphatic or aromatic hydrocarbon radicals having from 1 to 30 carbon atoms, which preferably have between 1 and 5 hydroxyl groups, and x is values between 1 and 40.

In particular, preference is given to those end group-capped poly(oxyalkylated)nonionic surfactants which, according to the formula
R¹O[CH₂CH₂O]ₓCH₂CH(OH)R²,
in addition to an R¹ radical which is linear or branched, saturated or unsaturated, aliphatic or aromatic hydrocarbon radicals having from 1 to 30 carbon atoms, preferably having from 4 to 20 carbon atoms, also have a linear or branched, saturated or unsaturated, aliphatic or aromatic hydrocarbon radical R² having from 1 to 30 carbon atoms, which is adjacent to a monohydroxylated intermediate —CH₂CH(OH)— group. x in this formula is values between 1 and 90.

In particular, preference is given in the context of the present application to those machine dishwasher detergents which comprise nonionic surfactant(s) of the general formula
R¹O[CH₂CH₂O]ₓCH₂CH(OH)R²
which, in addition to an R¹ radical which is linear or branched, saturated or unsaturated, aliphatic or aromatic hydrocarbon radicals having from 1 to 30 carbon atoms, preferably having from 4 to 20 carbon atoms, also have a linear or branched, saturated or unsaturated, aliphatic or aromatic hydrocarbon radical R² having from 1 to 30 carbon atoms, which is adjacent to a monohydroxylated intermediate —CH₂CH(OH)— group, and in which x is values between 1 and 90.

With particular preference, the present application claims those machine dishwasher detergents which comprise nonionic surfactant(s) of the general formula
R¹O[CH₂CH₂O]ₓCH₂CH(OH)R²
which, in addition to an R¹ radical which is linear or branched, saturated or unsaturated, aliphatic or aromatic hydrocarbon radicals having from 1 to 30 carbon atoms, preferably having from 4 to 22 carbon atoms, also have a linear or branched, saturated or unsaturated, aliphatic or aromatic hydrocarbon radical R² having from 1 to 30 carbon atoms, preferably from 2 to 22 carbon atoms, which is adjacent to a monohydroxylated intermediate —CH₂CH(OH)— group, and in which x is values between 40 and 80, preferably values between 40 and 60.

The corresponding end group-capped poly(oxyalkylated)nonionic surfactants of the formula above can be obtained, for example, by reacting a terminal epoxide of the formula R²CH(O)CH₂ with an ethoxylated alcohol of the formula R¹O[CH₂CH₂O]ₓ₋₁CH₂CH₂OH.

Particular preference is further given to those poly(oxyalkylated)nonionic surfactants of the formula
R¹O[CH₂CH₂O]ₓ[CH₂CH(CH₃)O]_{y}CH₂CH(OH)R²
in which R¹ and R² are each independently a linear or branched, saturated or mono- or polyunsaturated hydrocarbon radical having from 2 to 26 carbon atoms, R³ is independently selected from —CH₃, —CH₂CH₃, —CH₂CH₂—CH₃, CH(CH₃)₂, but is preferably —CH₃, and x and y are each independently values between 1 and 32, very particular preference being given to nonionic surfactants having values for x of from 15 to 32 and for y of 0.5 and 1.5.

In the context of the present application, machine dishwasher detergents which comprise nonionic surfactant(s) of the general formula 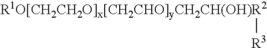
in which R¹ and R² are each independently a linear or branched, saturated or mono- or polyunsaturated hydrocarbon radical having from 2 to 26 carbon atoms, R³ is independently selected from —CH₃, —CH₂CH₃, —CH₂CH₂—CH₃, —CH(CH₃)₂, but is preferably —CH₃, and x and y are each independently values between 1 and 32, very particular preference being given to nonionic surfactants having values for x of from 15 to 32 and for y of 0.5 and 1.5, form part of preferred inventive compositions.

The carbon chain lengths and degrees of ethoxylation or degrees of alkoxylation specified for the aforementioned nonionic surfactants are statistical averages which, for a specific product, may be an integer or a fraction. Owing to the preparation process, commercial products of the formulae mentioned do not usually consist of an individual representative but rather of mixtures, which can give rise to averages and consequently fractions both for the carbon chain lengths and for the degrees of ethoxylation and degrees of alkoxylation.

It will be appreciated that the inventive machine dishwasher detergents may comprise the aforementioned nonionic surfactants not only as individual substances but also as surfactant mixtures of two, three, four or more surfactants. Surfactant mixtures do not refer to mixtures of nonionic surfactants which, in their entirety, fall under one of the above-mentioned general formulae but rather to those mixtures which comprise two, three, four or more nonionic surfactants which can be described by different general formulae among those mentioned above.

In the context of this application, preference is given in particular to machine dishwasher detergents comprising from 0.5 to 12% by weight of a surfactant system composed of
a) at least one nonionic surfactant F of the general formula
   R¹—CH(OH)CH₂O-(AO)_{w}-(A′O)ₓ-(A″O)_{y}-(A′″O)₂—R² in which
   R¹ is a straight-chain or branched, saturated or mono- or polyunsaturated C₆₋₂₄-alkyl or -alkenyl radical;
   R² is a linear or branched hydrocarbon radical having from 2 to 26 carbon atoms;
   A, A′, A″ and A′″ are each independently a radical from the group of —CH₂CH₂, —CH₂CH₂—CH₂, —CH₂—CH(CH₃), —CH₂—CH₂—CH₂—CH₂, —CH₂—CH(CH₃)—CH₂—, —CH₂—CH(CH₂—CH₃),
   w, x, y and z are values between 0.5 and 25, where x, y and/or z may also be 0; and
b) at least one nonionic surfactant G of the general formula
   R¹—O-(AO)_{w}-(A′O)ₓ-(A″O)_{y}-(A′″O)_{z}—R² in which
R¹ is a straight-chain or branched, saturated or mono- or polyunsaturated C₆₋₂₄-alkyl or -alkenyl radical;
   R² is H or a linear or branched hydrocarbon radical having from 2 to 26 carbon atoms;
   A, A′, A″ and A′″ are each independently a radical from the group of —CH₂CH₂, —CH₂CH₂—CH₂, —CH₂—CH(CH₃), —CH₂—CH₂—CH₂—CH₂, —CH₂—CH(CH₃)—CH₂—, —CH₂—CH(CH₂—CH₃),
   w, x, y and z are values between 0.5 and 25, where x, y and/or z may also be 0; and
      where the surfactant system contains the nonionic surfactants F and G in a weight ratio of F:G between 1:4 and 100:1.

Particular preference is given in the context of this application to those machine dishwasher detergents which comprise a surfactant system which includes a nonionic surfactant F of the general formula R¹O[CH₂CH₂O]ₓCH₂CH(OH)R² in which R¹ is a saturated, unbranched aliphatic hydrocarbon radical having from 8 to 12 carbon atoms, preferably having 10 carbon atoms, and R is a saturated, linear hydrocarbon radical having from 8 to 12 carbon atoms, preferably having 8 carbon atoms, and in which x is values between 14 and 26, preferably values of from 20 to 24, which is combined with a nonionic surfactant G of the general formula 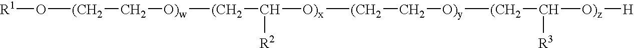
in which R¹ is a straight-chain or branched, saturated or mono- or polyunsaturated C₆₋₂₄-alkyl or -alkenyl radical; each R² and R³ group is selected independently from —CH₃; —CH₂CH₃, —CH₂CH₂—CH₃, CH(CH₃)₂, and the indices w, x, y, z are each independently integers from 1 to 6.

Preference is further given in the context of this application to those machine dishwasher detergents which comprise a surfactant system which includes a nonionic surfactant F of the general formula R¹O[CH₂CH(CH₃)O]ₓ[CH₂CH₂O]_{y}CH₂CH(OH)R² in which R¹ is a saturated, unbranched aliphatic hydrocarbon radical having from 8 to 12 carbon atoms, preferably having from 8 to 10 carbon atoms, and R² is a saturated, linear hydrocarbon radical having from 8 to 12 carbon atoms, preferably having 8 carbon atoms, and in which x is values of 1 or 2, while y is values between 18 and 24, preferably values of from 20 to 24, which is combined with a nonionic surfactant G of the general formula 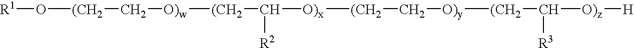
in which R¹ is a straight-chain or branched, saturated or mono- or polyunsaturated C₆₋₂₄-alkyl or -alkenyl radical; each R² and R³ group is selected independently from —CH₃; —CH₂CH₃, —CH₂CH₂—CH₃, CH(CH₃)₂, and the indices w, x, y, z are each independently integers from 1 to 6.

The anionic surfactants used are, for example, those of the sulfonate and sulfate type. Useful surfactants of the sulfonate type are preferably C₉₋₁₃-alkylbenzenesulfonates, olefinsulfonates, i.e. mixtures of alkene- and hydroxyalkanesulfonates, and disulfonates, as are obtained, for example, from C₁₂₋₁₈-monoolefins with terminal or internal double bond by sulfonation with gaseous sulfur trioxide and subsequent alkaline or acidic hydrolysis of the sulfonation products. Also suitable are alkanesulfonates which are obtained from C₁₂₋₁₈-alkanes, for example by sulfochlorination or sulfoxidation with subsequent hydrolysis or neutralization. The esters of α-sulfo fatty acids (ester sulfonates), for example the α-sulfonated methyl esters of hydrogenated coconut, palm kernel or tallow fatty acids, are also likewise suitable.

Further suitable anionic surfactants are sulfated fatty acid glycerol esters. Fatty acid glycerol esters refer to the mono-, di- and triesters, and mixtures thereof, as are obtained in the preparation by esterification of a monoglycerol with from 1 to 3 mol of fatty acid or in the transesterification of triglycerides with from 0.3 to 2 mol of glycerol. Preferred sulfated fatty acid glycerol esters are the sulfation products of saturated fatty acids having from 6 to 22 carbon atoms, for example of caproic acid, caprylic acid, capric acid, myristic acid, lauric acid, palmitic acid, stearic acid or behenic acid.

Preferred alk(en)yl sulfates are the alkali metal and in particular the sodium salts of the sulfuric monoesters of C₁₂-C₁₈ fatty alcohols, for example of coconut fatty alcohol, tallow fatty alcohol, lauryl, myristyl, cetyl or stearyl alcohol, or of C₁₀-C₂₀ oxo alcohols and those monoesters of secondary alcohols of these chain lengths. Also preferred are alk(en)yl sulfates of the chain length mentioned which contain a synthetic straight-chain alkyl radical prepared on a petrochemical basis and which have analogous degradation behavior to the equivalent compounds based on fatty chemical raw materials. From the washing point of view, preference is given to the C₁₂-C₁₆-alkyl sulfates and C₁₂-C₁₅-alkyl sulfates, and C₁₄-C₁₅-alkyl sulfates. 2,3-Alkyl sulfates, which can be obtained as commercial products from the Shell Oil Company under the name DAN®, are also suitable anionic surfactants.

Also suitable are the sulfuric monoesters of the straight-chain or branched C₇₋₂₁-alcohols ethoxylated with 1 to 6 mol of ethylene oxide, such as 2-methyl-branched C₉₋₁₁-alcohols with on average 3.5 mol of ethylene oxide (EO) or C₁₂₋₁₈-fatty alcohols with from 1 to 4 EO. Owing to their high tendency to foam, they are used in cleaning compositions only in relatively small amounts, for example in amounts of from 1 to 5% by weight.

Further suitable anionic surfactants are also the salts of alkylsulfosuccinic acid, which are also referred to as sulfosuccinates or as sulfosuccinic esters and are the monoesters and/or diesters of sulfosuccinic acid with alcohols, preferably fatty alcohols and in particular ethoxylated fatty alcohols. Preferred sulfosuccinates contain C₈₋₁₈ fatty alcohol radicals or mixtures thereof. Especially preferred sulfosuccinates contain a fatty alcohol radical which is derived from ethoxylated fatty alcohols which, considered alone, constitute nonionic surfactants (for description see below). In this context, particular preference is again given to sulfosuccinates whose fatty alcohol radicals are derived from ethoxylated fatty alcohols with a narrowed homolog distribution. It is also equally possible to use alk(en)ylsuccinic acid having preferably from 8 to 18 carbon atoms in the alk(en)yl chain or salts thereof.

Useful further anionic surfactants are in particular soaps. Suitable soaps are saturated fatty acid soaps, such as the salts of lauric acid, myristic acid, palmitic acid, stearic acid, hydrogenated erucic acid and behenic acid, and soap mixtures derived in particular from natural fatty acids, for example coconut, palm kernel or tallow fatty acids.

The anionic surfactants including the soaps may be present in the form of their sodium, potassium or ammonium salts, and also in the form of soluble salts of organic bases, such as mono-, di- or triethanolamine. The anionic surfactants are preferably present in the form of their sodium or potassium salts, in particular in the form of the sodium salts.

When the anionic surfactants are a constituent of machine dishwasher detergents, their content, based on the total weight of the compositions, is preferably less than 4% by weight, preferentially less than 2% by weight and most preferably less than 1% by weight. Special preference is given to machine dishwasher detergents which do not contain any anionic surfactants.

Instead of the surfactants mentioned or in conjunction with them, it is also possible to use cationic and/or amphoteric surfactants.

The cationic active substances used may, for example, be cationic compounds of the formulae III, IV or V: 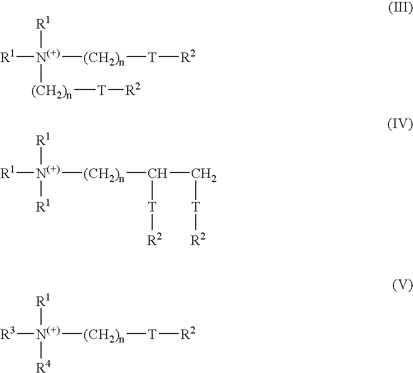
in which each R¹ group is independently selected from C₁₋₆alkyl, -alkenyl or -hydroxyalkyl groups; each R² group is independently selected from C₈₋₂₈-alkyl or -alkenyl groups; R³═R¹ or (CH₂)ₙ-T-R²; R⁴═R¹ or R² or (CH₂)ₙ-T-R²; T=—CH₂—, —O—CO— or —CO—O— and n is an integer from 0 to 5.

In machine dishwasher detergents, the content of cationic and/or amphoteric surfactants is preferably less than 6% by weight, preferentially less than 4% by weight, even more preferably less than 2% by weight and in particular less than 1% by weight. Particular preference is given to machine dishwasher detergents which do not contain any cationic or amphoteric surfactants.

Polymers

The group of polymers includes in particular the washing- or cleaning-active polymers, for example the rinse aid polymers and/or polymers active as softeners. Generally, not only nonionic polymers but also cationic, anionic and amphoteric polymers can be used in washing and cleaning compositions.

“Cationic polymers” in the context of the present invention are polymers which bear a positive charge in the polymer molecule. This can be realized, for example, by (alkyl)ammonium moieties present in the polymer chain or other positively charged groups. Particularly preferred cationic polymers stem from the groups of the quaternized cellulose derivatives, the polysiloxanes with quaternary groups, the cationic guar derivatives, the polymer dimethyldiallylammonium salts and copolymers thereof with esters and amides of acrylic acid and methacrylic acid, the copolymers of vinylpyrrolidone with quaternized derivatives of dialkylaminoacrylate and -methacrylate, the vinylpyrrolidone-methoimidazolinium chloride copolymers, the quaternized polyvinyl alcohols, or the polymers specified under the INCI designations Polyquaternium 2, Polyquaternium 17, Polyquaternium 18 and Polyquaternium 27.

“Amphoteric polymers” in the context of the present invention have, in addition to a positively charged group in the polymer chain, also negatively charged groups or monomer units. These groups may, for example, be carboxylic acids, sulfonic acids or phosphonic acids.

Particular preference is given in the context of the present application to washing or cleaning compositions, especially machine dishwasher detergents, characterized in that they comprise a polymer a) which contains monomer units of the formula R¹R²C═CR³R⁴ in which each R¹, R², R³, R⁴ radical is independently selected from hydrogen, derivatized hydroxyl group, C1 to C30 linear or branched alkyl groups, aryl, aryl-substituted C₁₋₃₀ linear or branched alkyl groups, polyalkoxylated alkyl groups, heteroaromatic organic groups having at least one positive charge without charged nitrogen, at least one quaternized nitrogen atom or at least one amino group having a positive charge in the partial region of the pH range from 2 to 11, or salts thereof, with the proviso that at least one R¹, R², R³, R⁴ radical is a heteroatomic organic group having at least one positive charge without charged nitrogen, at least one quaternized nitrogen atom or at least one amino group having a positive charge.

Cationic or amphoteric polymers particularly preferred in the context of the present application contain, as a monomer unit, a compound of the general formula (I) 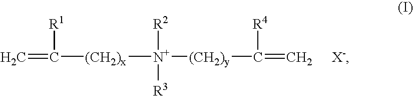
in which R¹ and R⁴ are each independently H or a linear or branched hydrocarbon radical having from 1 to 6 carbon atoms; R² and R³ are each independently an alkyl, hydroxyalkyl or aminoalkyl group in which the alkyl radical is linear or branched and has between 1 and 6 carbon atoms, which is preferably a methyl group; x and y are each independently integers between 1 and 3. X⁻ represents a counterion, preferably a counterion from the group of chloride, bromide, iodide, sulfate, hydrogensulfate, methosulfate, lauryl sulfate, dodecylbenzenesulfonate, p-toluenesulfonate(tosylate), cumene-sulfonate, xylenesulfonate, phosphate, citrate, formate, acetate or mixtures thereof.

Preferred R¹ and R⁴ radicals in the above formula (VII) are selected from —CH₃, —CH₂—CH₃, —CH₂—CH₂—CH₃, —CH(CH₃)—CH₃, —CH₂—OH, —CH₂—CH₂—OH, —CH(OH)—CH₃, —CH₂—CH₂—CH₂—OH, —CH₂CH(OH)—CH₃, —CH(OH)—CH₂—CH₃, and —(CH₂CH₂—O)ₙH.

Very particular preference is given in the context of the present application to polymers which have a cationic monomer unit of the general formula (I) in which R¹ and R⁴ are each H, R² and R³ are each methyl and x and y are each 1. The corresponding monomer units of the formula
H₂C═CH—(CH₂)—N⁺(CH₃)₂—(CH₂)—CH═CH₂X⁻
are, in the case that X⁻=chloride, also referred to as DADMAC (diallyldimethylammonium chloride).

Further cationic or amphoteric polymers particularly preferred in the context of the present application contain a monomer unit of the general formula (II)
R¹HC═CR²—C(O)—NH—(CH₂)ₓ—N⁺R³R⁴R⁵X⁻ (II)
in which R¹, R², R³, R⁴ and R⁵ are each independently a linear or branched, saturated or unsaturated alkyl or hydroxyalkyl radical having from 1 to 6 carbon atoms, preferably a linear or branched alkyl radical selected from —CH₃, —CH₂—CH₃, —CH₂—CH₂—CH₃, —CH(CH₃)—CH₃, —CH₂—OH, —CH₂—CH₂—OH, —CH(OH)—CH₃, —CH₂—CH₂—CH₂—OH, —CH₂CH(OH)—CH₃, —CH(OH)—CH₂—CH₃, and —(CH₂CH₂—O)ₙH, and x is an integer between 1 and 6.

Very particular preference is given in the context of the present application to polymers which have a cationic monomer unit of the general formula (II) in which R¹ is H and R², R³, R⁴ and R⁵ are each methyl and x is 3. The corresponding monomer units of the formula
H₂C═C(CH₃)—C(O)—NH—(CH₂)ₓ—N⁺(CH₃)₃X⁻
are, in the case
that X⁻=chloride, also referred to as MAPTAC (methacrylamidopropyltrimethylammonium chloride).

Washing or cleaning compositions preferred in accordance with the invention, especially machine dishwasher detergents, are characterized in that the polymer a) contains, as monomer units, diallyldimethylammonium salts and/or acrylamidopropyltrimethylammonium salts.

The aforementioned amphoteric polymers have not only cationic groups but also anionic groups or monomer units. Such anionic monomer units stem, for example, from the group of the linear or branched, saturated or unsaturated carboxylates, the linear or branched, saturated or unsaturated phosphonates, the linear or branched, saturated or unsaturated sulfates or the linear or branched, saturated or unsaturated sulfonates. Preferred monomer units are acrylic acid, the (meth)acrylic acids, (dimethyl)acrylic acid, (ethyl)acrylic acid, cyanoacrylic acid, vinylacetic acid, allylacetic acid, crotonic acid, maleic acid, fumaric acid, cinnamic acid and derivatives thereof, the allylsulfonic acids, for example allyloxybenzenesulfonic acid and methallylsulfonic acid, or the allylphosphonic acids.

Preferred usable amphoteric polymers stem from the group of the alkylacrylamide/acrylic acid copolymers, the alkylacrylamide/methacrylic acid copolymers, the alkylacrylamide/methylmethacrylic acid copolymers, the alkylacrylamide/acrylic acid/alkylaminoalkyl(meth)acrylic acid copolymers, the alkylacrylamide/methacrylic acid/alkylaminoalkyl(meth)acrylic acid copolymers, the alkylacrylamide/methylmethacrylic acid/alkylaminoalkyl(meth)acrylic acid copolymers, the alkylacrylamide/alkyl methacrylate/alkyl-aminoethyl methacrylate/alkyl methacrylate copolymers, and the copolymers formed from unsaturated carboxylic acids, cationically derived unsaturated carboxylic acids and optionally further ionic or nonionogenic monomers.

Zwitterionic polymers usable with preference stem from the group of the acrylamidoalkyltrialkylammonium chloride/acrylic acid copolymers and their alkali metal and ammonium salts, the acrylamidoalkyltrialkylammonium chloride/methacrylic acid copolymers and their alkali metal and ammonium salts, and the methacryloylethylbetaine/methacrylate copolymers.

Preference is further given to amphoteric polymers which, in addition to one or more anionic monomers, comprise, as cationic monomers, methacrylamidoalkyltrialkylammonium chloride and dimethyl(diallyl)ammonium chloride.

Particularly preferred amphoteric polymers stem from the group of the methacrylamidoalkyltrialkylammonium chloride/dimethyl(diallyl)ammonium chloride/acrylic acid copolymers, the methacrylamidoalkyltrialkylammonium chloride/dimethyl(diallyl)ammonium chloride/methacrylic acid copolymers and the methacrylamidoalkyltrialkylammonium chloride/dimethyl(diallyl)ammonium chloride/alkyl(meth)acrylic acid copolymers and their alkali metal and ammonium salts.

Especially preferred are amphoteric polymers from the group of the methacrylamidopropyltrimethylammonium chloride/dimethyl(diallyl)ammonium chloride/acrylic acid copolymers, the methacrylamidopropyltrimethylammonium chloride/dimethyl(diallyl)ammonium chloride/acrylic acid copolymers and the methacrylamidopropyltrimethylammonium chloride/dimethyl(diallyl)ammonium chloride/alkyl(meth)acrylic acid copolymers and their alkali metal and ammonium salts.

In a particularly preferred embodiment of the present invention, the polymers which are present in the inventive compositions and have a molar mass of 2000 gmol⁻¹ or higher are present in prefinished form. Suitable means of finishing the polymers include
encapsulation of the polymers by means of water-soluble or water-dispersible coating compositions, preferably by means of water-soluble or water-dispersible natural or synthetic polymers;
the encapsulation of the polymers by means of water-insoluble, meltable coating compositions, preferably by means of water-insoluble coating compositions from the groups of the waxes or paraffins having a melting point above 30° C.;
the cogranulation of the polymers with inert support materials, preferably with support materials from the group of the washing- or cleaning-active substances, more preferably from the group of the builders or cobuilders.

The compositions preferred in accordance with the invention have a proportion by weight of the aforementioned polymers between 0.01 and 10% by weight, based in each case on the total weight of the washing or cleaning composition. However, preference is given in the context of the present application to those washing or cleaning compositions in which the proportion by weight of the polymer a) is between 0.01 and 8% by weight, preferably between 0.01 and 6% by weight, preferentially between 0.01 and 4% by weight, more preferably between 0.01 and 2% by weight and in particular between 0.01 and 1% by weight, based in each case on the total weight of the machine dishwasher detergent.

Polymers effective as softeners are, for example, the polymers containing sulfonic acid groups, which are used with particular preference.

Polymers which contain sulfonic acid groups and can be used with particular preference are copolymers of unsaturated carboxylic acids, monomers containing sulfonic acid groups and optionally further ionic or nonionogenic monomers.

In the context of the present invention, preference is given, as a monomer, to unsaturated carboxylic acids of the formula
R¹(R²)C═C(R³)COOH
in which R¹ to R³ are each independently —H, —CH₃, a straight-chain or branched saturated alkyl radical having from 2 to 12 carbon atoms, a straight-chain or branched, mono- or polyunsaturated alkenyl radical having from 2 to 12 carbon atoms, alkyl or alkenyl radicals as defined above and substituted by —NH₂, —OH or —COOH, or are —COOH or —COOR⁴ where R⁴ is a saturated or unsaturated, straight-chain or branched hydrocarbon radical having from 1 to 12 carbon atoms.

Among the unsaturated carboxylic acids which can be described by the formula above, preference is given in particular to acrylic acid (R¹═R²═R³═H), methacrylic acid (R¹═R²═H; R³═CH₃) and/or maleic acid (R¹═COOH; R²═R³═H).

The monomers containing sulfonic acid groups are preferably those of the formula
R⁵(R⁶)C═C(R⁷)—X—SO₃H
in which R⁵ to R⁷ are each independently —H, —CH₃, a straight-chain or branched saturated alkyl radical having from 2 to 12 carbon atoms, a straight-chain or branched, mono- or polyunsaturated alkenyl radical having from 2 to 12 carbon atoms, alkyl or alkenyl radicals as defined above and substituted by —NH₂, —OH or —COOH, or are —COOH or —COOR⁴ where R⁴ is a saturated or unsaturated, straight-chain or branched hydrocarbon radical having from 1 to 12 carbon atoms, and X is an optionally present spacer group which is selected from —(CH₂)ₙ— where n=from 0 to 4, —COO—(CH₂)ₖ— where k=from 1 to 6, —C(O)—NH—C(CH₃)₂— and —C(O)—NH—CH(CH₂CH₃)—.

Among these monomers, preference is given to those of the formulae
H₂C═CH—X—SO₃H
H₂C═C(CH₃)—X—SO₃H
HO₃S—X—(R⁶)C═C(R⁷)—X—SO₃H
in which R⁶ and R⁷ are each independently selected from —H, —CH₃, —CH₂CH₃, —CH₂CH₂CH₃, —CH(CH₃)₂ and X is an optionally present spacer group which is selected from —(CH₂)ₙ— where n=from 0 to 4, —COO—(CH₂)ₖ— where k=from 1 to 6, —C(O)—NH—C(CH₃)₂— and —C(O)—NH—CH(CH₂CH₃)—.

Particularly preferred monomers containing sulfonic acid groups are 1-acrylamido-1-propanesulfonic acid, 2-acrylamido-2-propanesulfonic acid, 2-acrylamido-2-methyl-1-propanesulfonic acid, 2-methacrylamido-2-methyl-1-propanesulfonic acid, 3-methacrylamido-2-hydroxypropanesulfonic acid, allylsulfonic acid, methallylsulfonic acid, allyloxybenzenesulfonic acid, methallyloxybenzenesulfonic acid, 2-hydroxy-3-(2-propenyloxy)propanesulfonic acid, 2-methyl-2-propene-1-sulfonic acid, styrenesulfonic acid, vinylsulfonic acid, 3-sulfopropyl acrylate, 3-sulfopropyl methacrylate, sulfomethacrylamide, sulfomethylmethacrylamide and water-soluble salts of the acids mentioned.

Useful further ionic or nonionogenic monomers are in particular ethylenically unsaturated compounds. The content of monomers of group iii) in the polymers used is preferably less than 20% by weight, based on the polymer. Polymers to be used with particular preference consist only of monomers of groups i) and ii).

In summary, particular preference is given to copolymers of

i) unsaturated carboxylic acids of the formula
R¹(R²)C═C(R³)COOH
in which R¹ to R³ are each independently —H, —CH₃, a straight-chain or branched saturated alkyl radical having from 2 to 12 carbon atoms, a straight-chain or branched, mono- or polyunsaturated alkenyl radical having from 2 to 12 carbon atoms, alkyl or alkenyl radicals as defined above and substituted by —NH₂, —OH or —COOH, or are —COOH or —COOR⁴ where R⁴ is a saturated or unsaturated, straight-chain or branched hydrocarbon radical having from 1 to 12 carbon atoms,
ii) monomers of the formula containing sulfonic acid groups
R¹(R⁶)C═C(R⁷)—X—SO₃H
in which R⁵ to R⁷ are each independently —H, —CH₃, a straight-chain or branched saturated alkyl radical having from 2 to 12 carbon atoms, a straight-chain or branched, mono- or polyunsaturated alkenyl radical having from 2 to 12 carbon atoms, alkyl or alkenyl radicals as defined above and substituted by —NH₂, —OH or —COOH, or are —COOH or —COOR⁴ where R⁴ is a saturated or unsaturated, straight-chain or branched hydrocarbon radical having from 1 to 12 carbon atoms, and X is an optionally present spacer group which is selected from —(CH₂)ₙ— where n=from 0 to 4, —COO—(CH₂)ₖ— where k=from 1 to 6, —C(O)—NH—C(CH₃)₂— and —C(O)—NH—CH(CH₂CH₃)—
iii) optionally further ionic or nonionogenic monomers.

Further particularly preferred copolymers consist of
i) one or more unsaturated carboxylic acids from the group of acrylic acid, methacrylic acid and/or maleic acid,
ii) one or more monomers containing sulfonic acid groups of the formulae:
   H₂C═CH—X—SO₃H
   H₂C═C(CH₃)—X—SO₃H
   HO₃S—X—(R⁶)C═C(R⁷)—X—SO₃H
   in which R⁶ and R⁷ are each independently selected from —H, —CH₃, —CH₂CH₃, —CH₂CH₂CH₃, —CH(CH₃)₂ and X is an optionally present spacer group which is selected from —(CH₂)ₙ— where n=from 0 to 4, —COO—(CH₂)ₖ— where k=from 1 to 6, —C(O)—NH—C(CH₃)₂— and —C(O)—NH—CH(CH₂CH₃)—
iii) optionally further ionic or nonionogenic monomers.

The copolymers may contain the monomers from groups i) and ii) and optionally iii) in varying amounts, and it is possible to combine any of the representatives from group i) with any of the representatives from group ii) and any of the representatives from group iii). Particularly preferred polymers have certain structural units which are described below.

Thus, preference is given, for example, to copolymers which contain structural units of the formula
—[CH₂—CHCOOH]ₘ—[CH₂—CHC(O)—Y—SO₃H]ₚ—
in which m and p are each a whole natural number between 1 and 2000, and Y is a spacer group which is selected from substituted or unsubstituted, aliphatic, aromatic or araliphatic hydrocarbon radicals having from 1 to 24 carbon atoms, preference being given to spacer groups in which Y is —O—(CH₂)ₙ— where n=from 0 to 4, is —O—(C₆H₄)—, is —NH—C(CH₃)₂— or —NH—CH(CH₂CH₃)—.

These polymers are prepared by copolymerization of acrylic acid with an acrylic acid derivative containing sulfonic acid groups. Copolymerizing the acrylic acid derivative containing sulfonic acid groups with methacrylic acid leads to another polymer, the use of which is likewise preferred. The corresponding copolymers contain structural units of the formula
—[CH₂—C(CH₃)COOH]ₘ—[CH₂—CHC(O)—Y—SO₃H]ₚ—
in which m and p are each a whole natural number between 1 and 2000, and Y is a spacer group which is selected from substituted or unsubstituted, aliphatic, aromatic or araliphatic hydrocarbon radicals having from 1 to 24 carbon atoms, preference being given to spacer groups in which Y is —O—(CH₂)ₙ— where n=from 0 to 4, is —O—(C₆H₄)—, is —NH—C(CH₃)₂— or —NH—CH(CH₂CH₃)—.

Acrylic acid and/or methacrylic acid can also be copolymerized entirely analogously with methacrylic acid derivatives containing sulfonic acid groups, which changes the structural units within the molecule. Thus, copolymers which contain structural units of the formula
—[CH₂—CHCOOH]ₘ—[CH₂—C(CH₃)C(O)—Y—SO₃H]ₚ—
in which m and p are each a whole natural number between 1 and 2000, and Y is a spacer group which is selected from substituted or unsubstituted, aliphatic, aromatic or araliphatic hydrocarbon radicals having from 1 to 24 carbon atoms, preference being given to spacer groups in which Y is —O—(CH₂)ₙ— where n=from 0 to 4, is —O—(C₆H₄)—, is —NH—C(CH₃)₂— or —NH—CH(CH₂CH₃)—, are just as preferred as copolymers which contain structural units of the formula
—[CH₂—C(CH₃)COOH]ₘ—[CH₂—C(CH₃)C(O)—Y—SO₃H]ₚ—
in which m and p are each a whole natural number between 1 and 2000, and Y is a spacer group which is selected from substituted or unsubstituted, aliphatic, aromatic or araliphatic hydrocarbon radicals having from 1 to 24 carbon atoms, preference being given to spacer groups in which Y is —O—(CH₂)ₙ— where n=from 0 to 4, is —O—(C₆H₄)—, is —NH—C(CH₃)₂— or —NH—CH(CH₂CH₃)—.

Instead of acrylic acid and/or methacrylic acid, or in addition thereto, it is also possible to use maleic acid as a particularly preferred monomer from group i). This leads to copolymers which are preferred in accordance with the invention and contain structural units of the formula
—[HOOCCH—CHCOOH]ₘ—[CH₂—CHC(O)—Y—SO₃H]ₚ—
in which m and p are each a whole natural number between 1 and 2000, and Y is a spacer group which is selected from substituted or unsubstituted, aliphatic, aromatic or araliphatic hydrocarbon radicals having from 1 to 24 carbon atoms, preference being given to spacer groups in which Y is —O—(CH₂)ₙ— where n=from 0 to 4, is —O—(C₆H₄)—, is —NH—C(CH₃)₂— or —NH—CH(CH₂CH₃)—, and to copolymers which are preferred in accordance with the invention and contain structural units of the formula
—[HOOCCH—CHCOOH]ₘ—[CH₂—C(CH₃)C(O)O—Y—SO₃H]ₚ—
in which m and p are each a whole natural number between 1 and 2000, and Y is a spacer group which is selected from substituted or unsubstituted, aliphatic, aromatic or araliphatic hydrocarbon radicals having from 1 to 24 carbon atoms, preference being given to spacer groups in which Y is —O—(CH₂)ₙ— where n=from 0 to 4, is —O—(C₆H₄)—, is —NH—C(CH₃)₂— or —NH—CH(CH₂CH₃)—.

In summary, preference is given according to the invention to those copolymers which contain structural units of the formulae
—[CH₂—CHCOOH]ₘ—[CH₂—CHC(O)—Y—SO₃H]ₚ—
—[CH₂—C(CH₃)COOH]ₘ—[CH₂—CHC(O)—Y—SO₃H]ₚ—
—[CH₂—CHCOOH]ₘ—[CH₂—C(CH₃)C(O)—Y—SO₃H]ₚ—
—[CH₂—C(CH₃)COOH]ₘ—[CH₂—C(CH₃)C(O)—Y—SO₃H]ₚ—
—[HOOCCH—CHCOOH]ₘ—[CH₂—CHC(O)—Y—SO₃H]ₚ—
—[HOOCCH—CHCOOH]ₘ—[CH₂—C(CH₃)C(O)O—Y—SO₃H]ₚ—
in which m and p are each a whole natural number between 1 and 2000, and Y is a spacer group which is selected from substituted or unsubstituted, aliphatic, aromatic or araliphatic hydrocarbon radicals having from 1 to 24 carbon atoms, preference being given to spacer groups in which Y is —O—(CH₂)ₙ— where n=from 0 to 4, is —O—(C₆H₄)—, is —NH—C(CH₃)₂— or —NH—CH(CH₂CH₃)—.

In the polymers, all or some of the sulfonic acid groups may be in neutralized form, i.e. the acidic hydrogen atom of the sulfonic acid group may be replaced in some or all of the sulfonic acid groups by metal ions, preferably alkali metal ions and in particular by sodium ions. The use of copolymers containing partially or completely neutralized sulfonic acid groups is preferred in accordance with the invention.

The monomer distribution of the copolymers used with preference in accordance with the invention is, in the case of copolymers which contain only monomers from groups i) and ii), preferably in each case from 5 to 95% by weight of i) or ii), more preferably from 50 to 90% by weight of monomer from group i) and from 10 to 50% by weight of monomer from group ii), based in each case on the polymer.

In the case of terpolymers, particular preference is given to those which contain from 20 to 85% by weight of monomer from group i), from 10 to 60% by weight of monomer from group ii), and from 5 to 30% by weight of monomer from group iii).

The molar mass of the sulfo copolymers used with preference in accordance with the invention can be varied in order to adapt the properties of the polymers to the desired end use. Preferred washing or cleaning composition tablets are characterized in that the copolymers have molar masses of from 2000 to 200 000 gmol⁻¹, preferably from 4000 to 25 000 gmol⁻¹ and in particular from 5000 to 15 000 gmol⁻¹.

Bleaches

A preferred constituent of the inventive compositions is the bleach. Among the compounds which serve as bleaches and supply H₂O₂ in water, sodium percarbonate, sodium perborate tetrahydrate and sodium perborate monohydrdate are of particular significance. Further bleaches which can be used are, for example, peroxypyrophosphates, citrate perhydrates, and H₂O₂-supplying peracidic salts or peracids, such as perbenzoates, peroxophthalates, diperazelaic acid, phthaloimino peracid or diperdodecanedioic acid. Inventive cleaning compositions according to the invention may also comprise bleaches from the group of organic bleaches. Typical organic bleaches are the diacyl peroxides, for example dibenzoyl peroxide. Further typical organic bleaches are the peroxy acids, particular examples being the alkyl peroxy acids and the aryl peroxy acids. Preferred representatives are (a) the peroxybenzoic acid and ring-substituted derivatives thereof, such as alkylperoxybenzoic acids, but it is also possible to use peroxy-α-naphthoic acid and magnesium monoperphthalate, (b) the aliphatic or substituted aliphatic peroxy acids, such as peroxylauric acid, peroxystearic acid, ε-phthalimidoperoxycaproic acid [phthaloiminoperoxy-hexanoic acid (PAP)], o-carboxybenzamido-peroxycaproic acid, N-nonenylamidoperadipic acid and N-nonenylamidopersuccinates, and (c) aliphatic and araliphatic peroxydicarboxylic acids, such as 1,12-diperoxycarboxylic acid, 1,9-diperoxy-azelaic acid, diperoxysebacic acid, diperoxybrassylic acid, the diperoxyphthalic acids, 2-decyldiperoxybutane-1,4-dioic acid and N,N-terephthaloyldi(6-aminopercaproic acid).

The bleaches used in the inventive compositions may also be substances which release chlorine or bromine. Among suitable chlorine- or bromine-releasing materials, useful examples include heterocyclic N-bromoamides and N-chloroamides, for example trichloroisocyanuric acid, tribromoisocyanuric acid, dibromoisocyanuric acid and/or dichloroisocyanuric acid (DICA) and/or salts thereof with cations such as potassium and sodium. Hydantoin compounds, such as 1,3-dichloro-5,5-dimethylhydantoin, are likewise suitable.

Particular preference is given in the context of the present application to inventive compositions, especially machine dishwasher detergents, characterized in that they contain from 1 to 35% by weight, preferably from 2.5 to 30% by weight, more preferably from 3.5 to 20% by weight and in particular from 5 to 15% by weight of bleach, preferably sodium percarbonate.

The active oxygen context of the inventive compositions, especially machine dishwasher detergents, is, based in each case on the total weight of the dishwasher detergent, preferably between 0.4 and 10% by weight, more preferably between 0.5 and 8% by weight and in particular between 0.6 and 5% by weight. Particularly preferred dishwasher detergents have an active oxygen content above 0.3% by weight, preferably above 0.7% by weight, more preferably above 0.8% by weight and in particular above 1.0% by weight.

Bleach Activators

Bleach activators are used, for example, in washing or cleaning compositions, in order to achieve improved bleaching action when cleaning at temperatures of 60° C. and below. Bleach activators which may be used are compounds which, under perhydrolysis conditions, give rise to aliphatic peroxocarboxylic acids having preferably from 1 to 10 carbon atoms, in particular from 2 to 4 carbon atoms, and/or optionally substituted perbenzoic acid. Suitable substances bear O-acyl and/or N-acyl groups of the number of carbon atoms specified, and/or optionally substituted benzoyl groups. Preference is given to polyacylated alkylenediamines, in particular tetraacetylethylenediamine (TAED), acylated triazine derivatives, in particular 1,5-diacetyl-2,4-dioxohexahydro-1,3,5-triazine (DADHT), acylated glycolurils, in particular tetraacetylglycoluril (TAGU), N-acylimides, in particular N-nonanoylsuccinimide (NOSI), acylated phenolsulfonates, in particular n-nonanoyl- or isononanoyloxybenzenesulfonate (n- or iso-NOBS), carboxylic anhydrides, in particular phthalic anhydride, acylated polyhydric alcohols, in particular triacetin, ethylene glycol diacetate and 2,5-diacetoxy-2,5-dihydrofuran.

Further bleach activators used with preference in the context of the present application are compounds from the group of the cationic nitriles, especially cationic nitriles of the formula 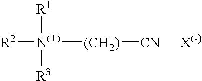
in which R¹ is —H, —CH₃, a C₂₋₂₄-alkyl or -alkenyl radical, a substituted C₂₋₂₄-alkyl or -alkenyl radical having at least one substituent from the group of —Cl, —Br, —OH, —NH₂, —CN, an alkyl- or alkenylaryl radical having a C₁₋₂₄-alkyl group, or is a substituted alkyl- or alkenylaryl radical having a C₁₋₂₄-alkyl group and at least one further substituent on the aromatic ring, R² and R³ are each independently selected from —CH₂—CN, —CH₃, —CH₂—CH₃, —CH₂—CH₂—CH₃, —CH(CH₃)—CH₃, —CH₂—OH, —CH₂—CH₂—OH, —CH(OH)—CH₃, —CH₂—CH₂—CH₂—OH, —CH₂—CH(OH)—CH₃, —CH(OH)—CH₂—CH₃, —(CH₂—CH₂—O)ₙH where n=1, 2, 3, 4, 5 or 6, and X is an anion.

Particular preference is given to a cationic nitrile of the formula 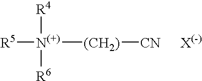
in which R⁴, R⁵ and R⁶ are each independently selected from —CH₃, —CH₂—CH₃, —CH₂—CH₂—CH₃, —CH(CH₃)—CH₃, where R⁴ may additionally also be —H, and X is an anion, it being preferred that R⁵═R⁶═—CH₃ and in particular R⁴═R⁵═R⁶═—CH₃, and particular preference being given to compounds of the formulae (CH₃)₃N⁽⁺⁾CH₂—CNX⁻, (CH₃CH₂)₃N⁽⁺⁾CH₂—CNX⁻, (CH₃CH₂CH₂)₃N⁽⁺⁾CH₂—CNX⁻, (CH₃CH(CH₃))₃N⁽⁺⁾CH₂—CNX⁻ or (HO—CH₂—CH₂)₃N⁽⁺⁾CH₂—CNX⁻, particular preference being given in turn, from this group of substances, to the cationic nitrile of the formula (CH₃)₃N⁽⁺⁾CH₂—CNX⁻ in which X⁻ is an anion which is selected from the group of chloride, bromide, iodide, hydrogensulfate, methosulfate, p-toluenesulfonate (tosylate) or xylenesulfonate.

The bleach activators used may also be compounds which, under perhydrolysis conditions, give rise to aliphatic peroxocarboxylic acids having preferably from 1 to 10 carbon atoms, in particular from 2 to 4 carbon atoms, and/or optionally substituted perbenzoic acid. Suitable substances bear O-acyl and/or N-acyl groups of the number of carbon atoms specified, and/or optionally substituted benzoyl groups. Preference is given to polyacylated alkylenediamines, in particular tetraacetylethylenediamine (TAED), acylated triazine derivatives, in particular 1,5-diacetyl-2,4-dioxohexahydro-1,3,5-triazine (DADHT), acylated glycolurils, in particular tetraacetylglycoluril (TAGU), N-acylimides, in particular N-nonanoylsuccinimide (NOSI), acylated phenolsulfonates, in particular n-nonanoyl- or isononanoyloxybenzenesulfonate (n- or iso-NOBS), carboxylic anhydrides, in particular phthalic anhydride, acylated polyhydric alcohols, in particular triacetin, ethylene glycol diacetate, 2,5-diacetoxy-2,5-dihydrofuran, n-methylmorpholiniumacetonitrile methylsulfate (MMA), and also acetylated sorbitol and mannitol or mixtures thereof (SORMAN), acylated sugar derivatives, in particular pentaacetylglucose (PAG), pentaacetylfructose, tetraacetylxylose and octaacetyllactose, and acetylated, optionally N-alkylated, glucamine and gluconolactone, and/or N-acylated lactams, for example N-benzoyl-caprolactam. Hydrophilically substituted acylacetals and acyllactams are likewise used with preference. Combinations of conventional bleach activators can also be used.

In addition to the conventional bleach activators, or instead of them, it is also possible to use so-called bleach catalysts. These substances are bleach-boosting transition metal salts or transition metal complexes, for example salen or carbonyl complexes of Mn, Fe, Co, Ru or Mo. It is also possible to use complexes of Mn, Fe, Co, Ru, Mo, Ti, V and Cu with N-containing tripod ligands, and also Co-, Fe-, Cu- and Ru-amine complexes as bleach catalysts.

When further bleach activators are to be used in addition to the nitrile quats, preference is given to using bleach activators from the group of the polyacylated alkylenediamines, in particular tetraacetylethylenediamine (TAED), N-acylimides, in particular N-nonanoylsuccinimide (NOSI), acylated phenolsulfonates, in particular n-nonanoyl- or isononanoyloxybenzenesulfonate (n- or iso-NOBS), n-methylmorpholiniumacetonitrile methylsulfate (MMA), preferably in amounts up to 10% by weight, in particular from 0.1% by weight to 8% by weight, particularly from 2 to 8% by weight and more preferably from 2 to 6% by weight, based in each case on the total weight of the composition containing bleach activator.

Bleach-boosting transition metal complexes, in particular with the central atoms Mn, Fe, Co, Cu, Mo, V, Ti and/or Ru, preferably selected from the group of manganese and/or cobalt salts and/or complexes, more preferably the cobalt(amine)complexes, the cobalt(acetate)complexes, the cobalt(carbonyl)complexes, the chlorides of cobalt or manganese, and manganese sulfate, are used in customary amounts, preferably in an amount up to 5% by weight, in particular from 0.0025% by weight to 1% by weight and more preferably from 0.01% by weight to 0.25% by weight, based in each case on the total weight of the composition containing bleach activator. In specific cases, though, it is also possible to use a greater amount of bleach activator.

Glass Corrosion Inhibitors

Glass corrosion inhibitors prevent the occurrence of cloudiness, smears and scratches, but also the iridescence of the glass surface of machine-cleaned glasses. Preferred glass corrosion inhibitors stem from the group of the magnesium and/or zinc salts and/or magnesium and/or zinc complexes.

A preferred class of compounds which can be used to prevent glass corrosion is that of insoluble zinc salts.

In the context of this preferred embodiment, insoluble zinc salts are zinc salts which have a maximum solubility of 10 grams of zinc salt per liter of water at 20° C. Examples of insoluble zinc salts which are particularly preferred in accordance with the invention are zinc silicate, zinc carbonate, zinc oxide, basic zinc carbonate (Zn₂(OH)₂CO₃), zinc hydroxide, zinc oxalate, zinc monophosphate (Zn₃(PO₄)₂) and zinc pyrophosphate (Zn₂(P₂O₇)).

The zinc compounds mentioned are preferably used in amounts which bring about a content of zinc ions in the compositions of between 0.02 and 10% by weight, preferably between 0.1 and 5.0% by weight and in particular between 0.2 and 1.0% by weight, based in each case on the overall composition containing glass corrosion inhibitor. The exact content in the compositions of the zinc salt or the zinc salts is by its nature dependent on the type of the zinc salts—the less soluble the zinc salt used, the higher its concentration in the compositions.

Since the insoluble zinc salts remain for the most part unchanged during the dishwashing operation, the particle size of the salts is a criterion to be considered, so that the salts do not adhere to glassware or parts of the machine. Preference is given here to compositions in which the insoluble zinc salts have a particle size below 1.7 millimeters.

When the maximum particle size of the insoluble zinc salts is less than 1.7 mm, there is no risk of insoluble residues in the dishwasher. The insoluble zinc salt preferably has an average particle size which is distinctly below this value in order to further minimize the risk of insoluble residues, for example an average particle size of less than 250 μm. The lower the solubility of the zinc salt, the more important this is. In addition, the glass corrosion-inhibiting effectiveness increases with decreasing particle size. In the case of very sparingly soluble zinc salts, the average particle size is preferably below 100 μm. For even more sparingly soluble salts, it may be lower still; for example, average particle sizes below 100 μm are preferred for the very sparingly soluble zinc oxide.

A further preferred class of compounds is that of magnesium and/or zinc salt(s) of at least one monomeric and/or polymeric organic acid. These have the effect that, even upon repeated use, the surfaces of glassware are not altered as a result of corrosion, and in particular no cloudiness, smears or scratches, and also no iridescence of the glass surfaces, are caused.

Even though all magnesium and/or zinc salt(s) of monomeric and/or polymeric organic acids may be used, preference is given, as described above, to the magnesium and/or zinc salts of monomeric and/or polymeric organic acids from the groups of the unbranched, saturated or unsaturated monocarboxylic acids, the branched, saturated or unsaturated monocarboxylic acids, the saturated and unsaturated dicarboxylic acids, the aromatic mono-, di- and tricarboxylic acids, the sugar acids, the hydroxy acids, the oxo acids, the amino acids and/or the polymeric carboxylic acids.

The spectrum of the zinc salts, preferred in accordance with the invention, of organic acids, preferably of organic carboxylic acids, ranges from salts which are sparingly soluble or insoluble in water, i.e. have a solubility below 100 mg/l, preferably below 10 mg/l, in particular have zero solubility, to those salts which have a solubility in water above 100 mg/l, preferably above 500 mg/l, more preferably above 1 g/l and in particular above 5 g/l (all solubilities at water temperature 20° C.). The first group of zinc salts includes, for example, zinc citrate, zinc oleate and zinc stearate; the group of soluble zinc salts includes, for example, zinc formate, zinc acetate, zinc lactate and zinc gluconate.

With particular preference, the glass corrosion inhibitor used is at least one zinc salt of an organic carboxylic acid, more preferably a zinc salt from the group of zinc stearate, zinc oleate, zinc gluconate, zinc acetate, zinc lactate and/or zinc citrate. Preference is also given to zinc ricinoleate, zinc abietate and zinc oxalate.

In the context of the present invention, the content of zinc salt in cleaning compositions is preferably between 0.1 and 5% by weight, preferably between 0.2 and 4% by weight and in particular between 0.4 and 3% by weight, or the content of zinc in oxidized form (calculated as Zn²⁺) is between 0.01 and 1% by weight, preferably between 0.02 and 0.5% by weight and in particular between 0.04 and 0.2% by weight, based in each case on the total weight of the composition containing glass corrosion inhibitor.

Corrosion Inhibitors

Corrosion inhibitors serve to protect the ware or the machine, particularly silver protectants having particular significance in the field of machine dishwashing. It is possible to use the known substances from the prior art. In general, it is possible in particular to use silver protectants selected from the group of the triazoles, the benzotriazoles, the bisbenzotriazoles, the aminotriazoles, the alkylaminotriazoles and the transition metal salts or complexes. Particular preference is given to using benzotriazole and/or alkylaminotriazole. Examples of the 3-amino-5-alkyl-1,2,4-triazoles to be used with preference in accordance with the invention include: 5-propyl-, -butyl-, -pentyl-, -heptyl-, -octyl-, -nonyl-, -decyl-, -undecyl-, -dodecyl-, -isononyl-, -Versatic-10 acid alkyl-, -phenyl-, -p-tolyl-, -(4-tert-butylphenyl)-, -(4-methoxyphenyl)-, -(2-, -3-, -4-pyridyl)-, -(2-thienyl)-, -(5-methyl-2-furyl)-, -(5-oxo-2-pyrrolidinyl)-3-amino-1,2,4-triazole. In machine dishwasher detergents, the alkylamino-1,2,4-triazoles or their physiologically compatible salts are used in a concentration of from 0.001 to 10% by weight, preferably from 0.0025 to 2% by weight, more preferably from 0.01 to 0.04% by weight. Preferred acids for the salt formation are hydrochloric acid, sulfuric acid, phosphoric acid, carbonic acid, sulfurous acid, organic carboxylic acids such as acetic acid, glycolic acid, citric acid, succinic acid. Very particularly effective are 5-pentyl-, 5-heptyl-, 5-nonyl-, 5-undecyl-, 5-isononyl-, 5-Versatic-10 acid alkyl-3-amino-1,2,4-triazoles, and also mixtures of these substances.

Frequently also found in cleaning formulations are active chlorine-containing agents which can significantly reduce the corrosion of the silver surface. In chlorine-free cleaners, particularly oxygen- and nitrogen-containing organic redox-active compounds, such as di- and trihydric phenols, for example hydroquinone, pyrocatechol, hydroxyhydroquinone, gallic acid, phloroglucinol, pyrogallol and derivatives of these classes of compound. Salt- and complex-type inorganic compounds, such as salts of the metals Mn, Ti, Zr, Hf, V, Co and Ce, also frequently find use. Preference is given in this context to the transition metal salts which are selected from the group of manganese and/or cobalt salts and/or complexes, more preferably cobalt(amine)complexes, cobalt(acetate)complexes, cobalt(carbonyl)complexes, the chlorides of cobalt or manganese, and manganese sulfate. Zinc compounds may likewise be used to prevent corrosion on the ware.

Instead of or in addition to the above-described silver protectants, for example the benzotriazoles, it is possible to use redox-active substances. These substances are preferably inorganic redox-active substances from the group of the manganese, titanium, zirconium, hafnium, vanadium, cobalt and cerium salts and/or complexes, the metals preferably being in one of the oxidation states II, III, IV, V or VI.

The metal salts or metal complexes used should be at least partially soluble in water. The counterions suitable for the salt formation include all customary singly, doubly or triply negatively charged inorganic anions, for example oxide, sulfate, nitrate, fluoride, but also organic anions, for example stearate.

Metal complexes in the context of the invention are compounds which consist of a central atom and one or more ligands, and optionally additionally one or more of the abovementioned anions. The central atom is one of the abovementioned metals in one of the abovementioned oxidation states. The ligands are neutral molecules or anions which are mono- or polydentate; the term “ligands” in the context of the invention is explained in more detail, for example, in “Römpp Chemie Lexikon, Georg Thieme Verlag, Stuttgart/New York, 9th edition, 1990, page 2507”. When the charge of the central atom and the charge of the ligand(s) within a metal complex do not add up to zero, depending on whether there is a cationic or an anionic charge excess, either one or more of the abovementioned anions or one or more cations, for example sodium, potassium, ammonium ions, ensure that the charge balances. Suitable complexing agents are, for example, citrate, acetyl acetonate or 1-hydroxyethane-1,1-diphosphonate.

The definition of “oxidation state” customary in chemistry is reproduced, for example, in “Römpp Chemie Lexikon, Georg Thieme Verlag, Stuttgart/New York, 9th edition, 1991, page 3168”.

Particularly preferred metal salts and/or metal complexes are selected from the group of MnSO₄, Mn(II)citrate, Mn(II)stearate, Mn(II)acetylacetonate, Mn(II)[1-hydroxyethane-1,1-diphosphonate], V₂O₅, V₂O₄, VO₂, TiOSO₄, K₂TiF₆, K₂ZrF₆, CoSO₄, Co(NO₃)₂, Ce(NO₃)₃, and mixtures thereof, so that preferred inventive machine dishwasher detergents are characterized in that the metal salts and/or metal complexes are selected from the group consisting of MnSO₄, Mn(II)citrate, Mn(II)stearate, Mn(II)acetylacetonate, Mn(II)[1-hydroxyethane-1,1-diphosphonate], V₂O₅, V₂O₄, VO₂, TiOSO₄, K₂TiF₆, K₂ZrF₆, CoSO₄, Co(NO₃)₂, Ce(NO₃)₃.

These metal salts or metal complexes are generally commercial substances which can be used in the inventive compositions for the purposes of silver corrosion protection without prior cleaning. For example, the mixture of penta- and tetravalent vanadium (V₂O₅, VO₂, V₂O₄) known from the preparation of SO₃ (contact process) is therefore suitable, as is the titanyl sulfate, TiOSO₄, which is obtained by diluting a Ti(SO₄)₂ solution.

The inorganic redox-active substances, especially metal salts or metal complexes, are preferably coated, i.e. covered completely with a material which is water-tight, but slightly soluble at the cleaning temperatures, in order to prevent their premature disintegration or oxidation in the course of storage. Preferred coating materials which are applied by known methods, for instance by the melt coating method according to Sandwik from the foods industry, are paraffins, microcrystalline waxes, waxes of natural origin, such as carnauba wax, candelilla wax, beeswax, relatively high-melting alcohols, for example hexadecanol, soaps or fatty acids. The coating material which is solid at room temperature is applied to the material to be coated in the molten state, for example by centrifuging finely divided material to be coated in a continuous stream through a likewise continuously generated spray-mist zone of the molten coating material. The melting point has to be selected such that the coating material readily dissolves or rapidly melts during the silver treatment. The melting point should ideally be in the range between 45° C. and 65° C. and preferably in the 50° C. to 60° C. range.

The metal salts and/or metal complexes mentioned are present in cleaning compositions preferably in an amount of from 0.05 to 6% by weight, preferably from 0.2 to 2.5% by weight, based in each case on the overall composition containing corrosion inhibitor.

Enzymes

To increase the washing or cleaning performance of washing or cleaning compositions, it is possible to use enzymes. These include in particular proteases, amylases, lipases, hemicellulases, cellulases or oxidoreductases, and preferably mixtures thereof. These enzymes are in principle of natural origin; starting from the natural molecules, improved variants are available for use in washing and cleaning compositions and are preferably used accordingly. Inventive compositions preferably contain enzymes in total amounts of from 1×10⁻⁶ to 5 percent by weight based on active protein. The protein concentration may be determined with the aid of known methods, for example the BCA method or the biuret method.

Among the proteases, preference is given to those of the subtilisin type. Examples thereof include the subtilisins BPN′ and Carlsberg, protease PB92, the subtilisins 147 and 309, Bacillus lentus alkaline protease, subtilisin DY and the enzymes thermitase and proteinase K which can be classified to the subtilases but no longer to the subtilisins in the narrower sense, and the proteases TW3 and TW7. The subtilisin Carlsberg is available in a developed form under the trade name Alcalase® from Novozymes A/S, Bagsvaerd, Denmark. The subtilisins 147 and 309 are sold under the trade names Esperase® and Savinase® respectively by Novozymes. The variants listed under the name BLAP® are derived from the protease of Bacillus lentus DSM 5483.

Further examples of useful proteases are the enzymes available under the trade names Durazym®, Relase®, Everlase®, Nafizym, Natalase®, Kannase® and Ovozymes® from Novozymes, those under the trade names Purafect®, Purafect®OxP and Properase® from Genencor, that under the trade name Protosol® from Advanced Biochemicals Ltd., Thane, India, that under the trade name Wuxi® from Wuxi Snyder Bioproducts Ltd., China, those under the trade names Proleather® and Protease P® from Amano Pharmaceuticals Ltd., Nagoya, Japan and that under the name Proteinase K-16 from Kao Corp., Tokyo, Japan.

Examples of amylases which can be used in accordance with the invention are the α-amylases from Bacillus licheniformis, from B. amyloliquefaciens or from B. stearothermophilus and developments thereof which have been improved for use in washing and cleaning compositions. The B. licheniformis enzyme is available from Novozymes under the name Termamyl® and from Genencor under the name Purastar®ST. Development products of this α-amylase are obtainable from Novozymes under the trade names Duramyl® and Termamyl®ultra, from Genencor under the name Purastar®OxAm and from Daiwa Seiko Inc., Tokyo, Japan as Keistase®. The B. amyloliquefaciens α-amylase is sold by Novozymes under the name BAN®, and variants derived from the B. stearothermophilus α-amylase under the names BSG® and Novamyl®, likewise from Novozymes.

Enzymes which should additionally be emphasized for this purpose are the α-amylase from Bacillus sp. A 7-7 (DSM 12368), and the cyclodextrin glucanotransferase (CGTase) from B. agaradherens (DSM 9948).

Also suitable are the developments of α-amylase from Aspergillus niger and A. oryzae, which are available under the trade names Fungamyl® from Novozymes. Another commercial product is Amylase-LT®, for example.

Furthermore, lipases or cutinases may be used according to the invention, especially owing to their triglyceride-cleaving activities, but also in order to generate peracids in situ from suitable precursors. Examples thereof include the lipases which were originally obtainable from Humicola lanuginosa (Thermomyces lanuginosus) or have been developed, in particular those with the D96L amino acid substitution. They are sold, for example, under the trade names Lipolase®, Lipolase®Ultra, LipoPrime®, Lipozyme® and Lipex® by Novozymes. It is additionally possible, for example, to use the cutinases which have originally been isolated from Fusarium solani pisi and Humicola insolens. Lipases which are also useful can be obtained under the designations Lipase CE®, Lipase P®, Lipase B®, Lipase CES®, Lipase AKG®, Bacillis sp. Lipase®, Lipase AP®, Lipase M-AP® and Lipase AML® from Amano. Examples of lipases and cutinases from Genencor which can be used are those whose starting enzymes have originally been isolated from Pseudomonas mendocina and Fusarium solanii. Other important commercial products include the M1 Lipase® and Lipomax® preparations originally sold by Gist-Brocades and the enzymes sold under the names Lipase MY-30®, Lipase OF® and Lipase PL® by Meito Sangyo KK, Japan, and also the product Lumafast® from Genencor.

It is also possible to use enzymes which are combined under the term hemicellulases. These include, for example, mannanases, xanthane lyases, pectin lyases (=pectinases), pectin esterases, pectate lyases, xyloglucanases (=xylanases), pullulanases and β-glucanases. Suitable mannanases are available, for example, under the names Gamanase® and Pektinex AR® from Novozymes, under the name Rohapec® B1 L from AB Enzymes and under the name Pyrolase® from Diversa Corp., San Diego, Calif., USA. The β-glucanase obtained from B. subtilis is available under the name Cereflo® from Novozymes.

To enhance the bleaching action, it is possible in accordance with the invention to use oxidoreductases, for example oxidases, oxygenases, catalases, peroxidases, such as haloperoxidases, chloroperoxidases, bromoperoxidases, lignin peroxidases, glucose peroxidases or manganese peroxidases, dioxygenases or laccases (phenol oxidases, polyphenol oxidases). Suitable commercial products include Denilite® 1 and 2 from Novozymes. Advantageously, preferably organic, more preferably aromatic, compounds which interact with the enzymes are additionally added in order to enhance the activity of the oxidoreductases concerned (enhancers), or to ensure the electron flux in the event of large differences in the redox potentials of the oxidizing enzymes and the soilings (mediators).

The enzymes derive, for example, either originally from microorganisms, for example of the genera Bacillus, Streptomyces, Humicola, or Pseudomonas, and/or are produced in biotechnology processes known per se by suitable microorganisms, for instance by transgenic expression hosts of the genera Bacillus or filamentous fungi.

The enzymes in question are preferably purified via processes which are established per se, for example via precipitation, sedimentation, concentration, filtration of the liquid phases, microfiltration, ultrafiltration, the action of chemicals, deodorization or suitable combinations of these steps.

The enzymes may be used in any form established in the prior art. These include, for example, the solid preparations obtained by granulation, extrusion or lyophilization, or, especially in the case of liquid or gel-form compositions, solutions of the enzymes, advantageously highly concentrated, low in water and/or admixed with stabilizers.

Alternatively, the enzymes may be encapsulated either for the solid or for the liquid administration form, for example by spray-drying or extrusion of the enzyme solution together with a preferably natural polymer, or in the form of capsules, for example those in which the enzymes are enclosed as in a solidified gel, or in those of the core-shell type, in which an enzyme-containing core is coated with a water-, air- and/or chemical-impermeable protective layer. It is possible in layers applied thereto to additionally apply further active ingredients, for example stabilizers, emulsifiers, pigments, bleaches or dyes. Such capsules are applied by methods known per se, for example by agitated or roll granulation or in fluidized bed processes. Advantageously, such granules, for example as a result of application of polymeric film formers, are low-dusting and storage-stable owing to the coating.

It is also possible to formulate two or more enzymes together, so that a single granule has a plurality of enzyme activities.

A protein and/or enzyme may be protected, particularly during storage, from damage, for example inactivation, denaturation or decay, for instance by physical influences, oxidation or proteolytic cleavage. When the proteins and/or enzymes are obtained microbially, particular preference is given to inhibiting proteolysis, especially when the compositions also comprise proteases. For this purpose, inventive compositions may comprise stabilizers; the provision of such compositions constitutes a preferred embodiment of the present invention.

One group of stabilizers is that of reversible protease inhibitors. Frequently, benzamidine hydrochloride, borax, boric acids, boronic acids or salts or esters thereof are used, and of these in particular derivatives having aromatic groups, for example ortho-substituted, meta-substituted and para-substituted phenylboronic acids, or the salts or esters thereof. Peptidic protease inhibitors which should be mentioned include ovomucoid and leupeptin; an additional option is the formation of fusion proteins of proteases and peptide inhibitors.

Further enzyme stabilizers are amino alcohols such as mono-, di-, triethanol- and -propanolamine and mixtures thereof, aliphatic carboxylic acids up to C₁₂, such as succinic acid, other dicarboxylic acids or salts of the acids mentioned. Terminally capped fatty acid amide alkoxylates are also suitable as stabilizers. Certain organic acids used as builders are additionally capable of stabilizing an enzyme present.

Lower aliphatic alcohols, but in particular polyols, for example glycerol, ethylene glycol, propylene glycol or sorbitol, are other frequently used enzyme stabilizers. Calcium salts are likewise used, for example calcium acetate or calcium formate, as are magnesium salts.

Polyamide oligomers or polymeric compounds such as lignin, water-soluble vinyl copolymers or cellulose ethers, acrylic polymers and/or polyamides stabilize the enzyme preparation against influences including physical influences or pH fluctuations. Polyamine N-oxide-containing polymers act as enzyme stabilizers. Other polymeric stabilizers are the linear C₈-C₁₈ polyoxyalkylenes. Alkylpolyglycosides can stabilize the enzymatic components of the inventive composition and even increase their performance. Crosslinked N-containing compounds likewise act as enzyme stabilizers.

Reducing agents and antioxidants increase the stability of the enzymes against oxidative decay. An example of a sulfur-containing reducing agent is sodium sulfite.

Preference is given to using combinations of stabilizers, for example of polyols, boric acid and/or borax, the combination of boric acid or borate, reducing salts and succinic acid or other dicarboxylic acids or the combination of boric acid or borate with polyols or polyamino compounds and with reducing salts. The action of peptide-aldehyde stabilizers is increased by the combination with boric acid and/or boric acid derivatives and polyols, and further enhanced by the additional use of divalent cations, for example calcium ions.

Preference is given to using one or more enzymes and/or enzyme preparations, preferably solid protease preparations and/or amylase preparations, in amounts of from 0.1 to 5% by weight, preferably of from 0.2 to 4.5% by weight and in particular from 0.4 to 4% by weight, based in each case on the overall composition containing enzyme.

Disintegration Assistants

In order to ease the decomposition of prefabricated tablets, it is possible to incorporate disintegration assistants, known as tablet disintegrants, into these compositions, in order to shorten disintegration times. According to Römpp (9th edition, vol. 6, p. 4440) and Voigt “Lehrbuch der pharmazeutischen Technologie” [Textbook of pharmaceutical technology] (6th edition, 1987, p. 182-184), tablet disintegrants or disintegration accelerants refer to assistants which ensure the rapid decomposition of tablets in water or gastric juice and the release of pharmaceuticals in absorbable form.

These substances, which are also referred to as “breakup” agents owing to their action, increase their volume on ingress of water, and it is either the increase in the intrinsic volume (swelling) or the release of gases that can generate a pressure that causes the tablets to disintegrate into smaller particles. Disintegration assistants which have been known for some time are, for example, carbonate/citric acid systems, although other organic acids may also be used. Swelling disintegration assistants are, for example, synthetic polymers such as polyvinylpyrrolidone (PVP) or natural polymers or modified natural substances such as cellulose and starch and derivatives thereof, alginates or casein derivatives.

Preference is given to using disintegration assistants in amounts of from 0.5 to 10% by weight, preferably from 3 to 7% by weight and in particular from 4 to 6% by weight, based in each case on the total weight of the composition comprising disintegration assistant.

Preferred disintegrants used in the context of the present invention are disintegrants based on cellulose, so that preferred washing and cleaning compositions contain such a cellulose-based disintegrant in amounts of from 0.5 to 10% by weight, preferably from 3 to 7% by weight and in particular from 4 to 6% by weight. Pure cellulose has the formal empirical composition (C₆H₁₀O₅)ₙ and, viewed in a formal sense, is a β-1,4-polyacetal of cellobiose which is in turn formed from two molecules of glucose. Suitable celluloses consist of from approx. 500 to 5000 glucose units and accordingly have average molar masses of from 50 000 to 500 000. Useful cellulose-based disintegrants in the context of the present invention are also cellulose derivatives which are obtainable by polymer-like reactions from cellulose. Such chemically modified celluloses comprise, for example, products of esterifications and etherifications in which hydroxyl hydrogen atoms have been substituted. However, celluloses in which the hydroxyl groups have been replaced by functional groups which are not bonded via an oxygen atom can also be used as cellulose derivatives. The group of the cellulose derivatives includes, for example, alkali metal celluloses, carboxymethylcellulose (CMC), cellulose esters and ethers, and amino celluloses. The cellulose derivatives mentioned are preferably not used alone as disintegrants based on cellulose, but rather in a mixture with cellulose. The content of cellulose derivatives in these mixtures is preferably below 50% by weight, more preferably below 20% by weight, based on the disintegrant based on cellulose. The disintegrant based on cellulose which is used is more preferably pure cellulose which is free of cellulose derivatives.

The cellulose used as a disintegration assistant is preferably not used in finely divided form, but rather converted to a coarser form before admixing with the premixtures to be compressed, for example granulated or compacted. The particle sizes of such disintegrants are usually above 200 μm, preferably to an extent of at least 90% by weight between 300 and 1600 μm and in particular to an extent of at least 90% by weight between 400 and 1200 μm. The aforementioned coarser cellulose-based disintegration assistants which are described in detail in the documents cited are to be used with preference as disintegration assistants in the context of the present invention and are commercially available, for example under the name Arbocel® TF-30-HG from Rettenmaier.

As a further cellulose-based disintegrant or as a constituent of this component, it is possible to use microcrystalline cellulose. This microcrystalline cellulose is obtained by partial hydrolysis of celluloses under conditions which attack and fully dissolve only the amorphous regions (approx. 30% of the total cellulose mass) of the celluloses, but leave the crystalline regions (approx. 70%) undamaged. A subsequent deaggregation of the microfine celluloses formed by the hydrolysis affords the microcrystalline celluloses which have primary particle sizes of approx. 5 μm and can be compacted, for example, to granules having an average particle size of 200 μm.

Disintegration assistants preferred in the context of the present invention, preferably a cellulose-based disintegration assistant, preferably in granulated, cogranulated or compacted form, are present in the compositions containing disintegrant in amounts of from 0.5 to 10% by weight, preferably from 3 to 7% by weight and in particular from 4 to 6% by weight, based in each case on the total weight of the composition containing disintegrant.

According to the invention, gas-evolving effervescent systems may preferably additionally be used as tablet disintegration assistants. The gas-evolving effervescent system may consist of a single substance which releases a gas on contact with water. Among these compounds, mention should be made of magnesium peroxide in particular, which releases oxygen on contact with water. Typically, however, the gas-releasing effervescent system itself consists of at least two constituents which react with one another to form gas. While a multitude of systems which release, for example, nitrogen, oxygen or hydrogen are conceivable and practicable here, the effervescent system used in the inventive washing and cleaning compositions will be selectable on the basis of both economic and on the basis of environmental considerations. Preferred effervescent systems consist of alkali metal carbonate and/or alkali metal hydrogencarbonate and of an acidifier which is suitable for releasing carbon dioxide from the alkali metal salts in aqueous solution.

In the case of the alkali metal carbonates and/or alkali metal hydrogencarbonates, the sodium and potassium salts are distinctly preferred over the other salts for reasons of cost. It is of course not mandatory to use the pure alkali metal carbonates or alkali metal hydrogencarbonates in question; rather, mixtures of different carbonates and hydrogencarbonates may be preferred.

The effervescent system used is preferably from 2 to 20% by weight, preferably from 3 to 15% by weight and in particular from 5 to 10% by weight of an alkali metal carbonate or alkali metal hydrogencarbonate, and from 1 to 15% by weight, preferably from 2 to 12% by weight and in particular from 3 to 10% by weight of an acidifier, based in each case on the overall weight of the composition.

Acidifiers which release carbon dioxide from the alkali metal salts in aqueous solution and can be used are, for example, boric acid and also alkali metal hydrogensulfates, alkali metal dihydrogenphosphates and other inorganic salts. Preference is given, however, to the use of organic acidifiers, citric acid being a particularly preferred acidifier. However, it is also possible, in particular, to use the other solid mono-, oligo- and polycarboxylic acids. From this group, preference is given in turn to tartaric acid, succinic acid, malonic acid, adipic acid, maleic acid, fumaric acid, oxalic acid, and polyacrylic acid. It is likewise possible to use organic sulfonic acids such as amidosulfonic acid. A commercially available acidifier which can likewise be used with preference in the context of the present invention is Sokalan® DCS (trademark of BASF), a mixture of succinic acid (max. 31% by weight), glutaric acid (max. 50% by weight) and adipic acid (max. 33% by weight).

In the context of the present invention, preference is given to acidifiers in the effervescent system from the group of the organic di-, tri- and oligocarboxylic acids, or mixtures of these.

Fragrances

The perfume oils and/or fragrances used may be individual odorant compounds, for example the synthetic products of the ester, ether, aldehyde, ketone, alcohol and hydrocarbon type. Odorant compounds of the ester type are, for example, benzyl acetate, phenoxyethyl isobutyrate, p-tert-butylcyclohexyl acetate, linalyl acetate, dimethylbenzylcarbinyl acetate, phenylethyl acetate, linalyl benzoate, benzyl formate, ethyl methyl phenylglycinate, allyl cyclohexylpropionate, styrallyl propionate and benzyl salicylate. The ethers include, for example, benzyl ethyl ether; the aldehydes include, for example, the linear alkanals having 8-18 carbon atoms, citral, citronellal, citronellyloxyacetaldehyde, cyclamen aldehyde, hydroxycitronellal, lilial and bourgeonal; the ketones include, for example, the ionones, α-isomethylionone and methyl cedryl ketone; the alcohols include anethole, citronellol, eugenol, geraniol, linalool, phenylethyl alcohol and terpineol; the hydrocarbons include primarily the terpenes such as limonene and pinene. However, preference is given to using mixtures of different odorants which together produce a pleasing fragrance note. Such perfume oils may also comprise natural odorant mixtures, as are obtainable from vegetable sources, for example pine oil, citrus oil, jasmine oil, patchouli oil, rose oil or ylang-ylang oil. Likewise suitable are muscatel, sage oil, chamomile oil, clove oil, balm oil, mint oil, cinnamon leaf oil, lime blossom oil, juniper berry oil, vetiver oil, olibanum oil, galbanum oil and labdanum oil, and also orange blossom oil, neroli oil, orange peel oil and sandalwood oil.

The fragrances can be processed directly, but it may also be advantageous to apply the fragrances to carriers which ensure long-lasting fragrance by slower fragrance release. Useful such carrier materials have been found to be, for example, cyclodextrins, and the cyclodextrin-perfume complexes may additionally also be coated with further assistants.

Dyes

Preferred dyes, whose selection presents no difficulty at all to the person skilled in the art, have high storage stability and insensitivity toward the other ingredients of the compositions and to light, and also have no pronounced substantivity toward the substrates to be treated with the dye-containing compositions, such as glass, ceramic or plastic dishes, so as not to stain them.

In addition to the components described in detail so far, the inventive washing and cleaning compositions may comprise further ingredients which further improve the performance and/or esthetic properties of these compositions. In the context of the present invention, preferred compositions comprise one or more substances from the group of electrolytes, pH modifiers, fluorescers, hydrotropes, foam inhibitors, silicone oils, anti-redeposition agents, optical brighteners, graying inhibitors, shrink preventatives, anticrease agents, dye transfer inhibitors, active antimicrobial ingredients, germicides, fungicides, antioxidants, antistats, ironing aids, repellency and impregnation agents, antiswell and antislip agents and UV absorbers.

The electrolytes used from the group of the inorganic salts may be a wide range of highly varying salts. Preferred cations are the alkali metals and alkaline earth metals; preferred anions are the halides and sulfates. From a production point of view, preference is given to the use of NaCl or MgCl₂ in the inventive compositions.

In order to bring the pH of the inventive compositions into the desired range, it may be appropriate to use pH modifiers. It is possible here to use all known acids or alkalis, as long as their use is not forbidden on performance or ecological grounds or on grounds of consumer protection. Typically, the amount of these modifiers does not exceed 1% by weight of the overall formulation.

Useful foam inhibitors which may be used in the inventive compositions are, for example, soaps, paraffins or silicone oils, which may optionally be applied to carrier materials. Suitable antiredeposition agents, which are also referred to as soil repellents, are, for example, nonionic cellulose ethers, such as methylcellulose and methylhydroxypropylcellulose having a proportion of methoxy groups of from 15 to 30% by weight and of hydroxypropyl groups of from 1 to 15% by weight, based in each case on the nonionic cellulose ethers, and the prior art polymers of phthalic acid and/or terephthalic acid or derivatives thereof, in particular polymers of ethylene terephthalates and/or polyethylene glycol terephthalates or anionically and/or nonionically modified derivatives thereof. Among these, particular preference is given to the sulfonated derivatives of phthalic acid polymers and terephthalic acid polymers.

Optical brighteners (known as “whiteners”) may be added to the inventive compositions in order to eliminate graying and yellowing of the treated textiles. These substances attach to the fibers and bring about brightening and simulated bleaching action by converting invisible ultraviolet radiation to visible longer-wavelength light, in the course of which the ultraviolet light absorbed from sunlight is radiated as pale bluish fluorescence and, together with the yellow shade of the grayed or yellowed laundry, results in pure white. Suitable compounds stem, for example, from the substance classes of 4,4′-diamino-2,2′-stilbenedisulfonic acids (flavonic acids), 4,4′-distyrylbiphenyls, methylumbelliferones, coumarins, dihydroquinolinones, 1,3-diarylpyrazolines, naphthalimides, benzoxazole, benzisoxazole and benzimidazole systems, and the pyrene derivatives substituted by heterocycles.

Graying inhibitors have the task of keeping the soil detached from the fiber suspended in the liquor, thus preventing the soil from reattaching. Suitable for this purpose are water-soluble colloids, usually of organic nature, for example the water-soluble salts of polymeric carboxylic acids, size, gelatin, salts of ether sulfonic acids of starch or of cellulose, or salts of acidic sulfuric esters of cellulose or of starch. Water-soluble polyamides containing acidic groups are also suitable for this purpose. In addition, it is possible to use soluble starch preparations, and starch products other than those mentioned above, for example degraded starch, aldehyde starches, etc. It is also possible to use polyvinylpyrrolidone. Also usable as graying inhibitors are cellulose ethers such as carboxymethylcellulose (sodium salt), methylcellulose, hydroxyalkylcellulose and mixed ethers such as methylhydroxyethylcellulose, methyl hydroxypropylcellulose, methylcarboxymethylcellulose and mixtures thereof.

Since textile fabrics, in particular those made of rayon, viscose, cotton and mixtures thereof, can tend to crease because the individual fibers are sensitive toward bending, folding, compressing and crushing transverse to the fiber direction, the inventive compositions may comprise synthetic anticrease agents. These include, for example, synthetic products based on fatty acids, fatty acid esters, fatty acid amides, fatty acid alkylol esters, fatty acid alkylolamides or fatty alcohols, which have usually been reacted with ethylene oxide, or products based on lecithin or modified phosphoric esters.

Active antimicrobial ingredients can be used to control microorganisms. A distinction is drawn here, depending on the antimicrobial spectrum and mechanism of action, between bacteriostats and bactericides, fungistats and fungicides, etc. Important substances from these groups are, for example, benzalkonium chlorides, alkylarylsulfonates, halophenols and phenylmercuric acetate, although it is also possible to dispense entirely with these compounds in the inventive compositions.

In order to prevent undesired changes, caused by the action of oxygen and other oxidative processes, to the washing and cleaning compositions and/or the textiles treated, the compositions may comprise antioxidants. This class of compound includes, for example, substituted phenols, hydroquinones, pyrocatechols and aromatic amines, and also organic sulfides, polysulfides, dithiocarbamates, phosphites and phosphonates.

Increased wear comfort can result from the additional use of antistats which are additionally added to the inventive compositions. Antistats increase the surface conductivity and thus permit improved discharge of charges formed. External antistats are generally substances having at least one hydrophilic molecular ligand and impart to the surfaces a more or less hygroscopic film. These usually interface-active antistats can be subdivided into nitrogen antistats (amines, amides, quaternary ammonium compounds), phosphorus antistats (phosphoric esters) and sulfur antistats (alkylsulfonates, alkyl sulfates). Lauryl- (or stearyl)dimethylbenzylammonium chlorides are likewise suitable as antistats for textiles or as additives for washing compositions, in which case a softening effect is additionally achieved.

For the care of the textiles and for an improvement in the textile properties such as a softer “hand” (softening) and reduced electrostatic charge (increased wear comfort), the inventive compositions may comprise fabric softeners. The active ingredients in fabric softener formulations are ester quats, quaternary ammonium compounds having two hydrophobic radicals, for example distearyldimethylammonium chloride which, however, owing to its inadequate biodegradability, is increasingly being replaced by quaternary ammonium compounds which contain ester groups in their hydrophobic radicals as intended cleavage sites for biodegradation.

To improve the water-absorption capacity and the rewettability of the treated textiles, and to ease the ironing of these textiles, it is possible to use silicone derivatives, for example, in the inventive compositions. They additionally improve the rinse-out performance of the inventive compositions by virtue of their foam-inhibiting properties. Preferred silicone derivatives are, for example, polydialkyl- or alkylarylsiloxanes in which the alkyl groups have from one to five carbon atoms and are fully or partly fluorinated. Preferred silicones are polydimethylsiloxanes which may optionally be derivatized and are in that case amino-functional or quaternized or have Si—OH, Si—H and/or Si—Cl bonds.

Finally, the inventive compositions may also comprise UV absorbers which attach to the treated textiles and improve the photoresistance of the fibers. Compounds which have these desired properties are, for example, the compounds and derivatives of benzophenone having substituents in the 2- and/or 4-position which are active by virtue of radiationless deactivation. Also suitable are substituted benzotriazoles, 3-phenyl-substituted acrylates (cinnamic acid derivatives), optionally having cyano groups in the 2-position, salicylates, organic nickel complexes and natural substances such as umbelliferone and endogenous urocanic acid.

1-30. (canceled)

31. A process comprising:
(a) providing a molding having at least one cavity, wherein the at least one cavity has an opening on a surface of the molding;
(b) applying a first film material over the opening of the at least one cavity;
(c) thermoforming the first film material into the at least one cavity; and
(d) introducing a substance selected from the group consisting of washing actives, cleaning actives and mixtures thereof into the at least one cavity.

32. The process according to claim 31, wherein the molding comprises a form selected from the group consisting of tablets, compactates, extrudates, injection moldings, castings, and combinations thereof.

33. The process according to claim 31, wherein the molding has a coating on at least a portion of the surface of the molding.

34. The process according to claim 31, wherein the substance is introduced into the at least one cavity in an amount such that a ratio of molding volume to substance volume is 1:1 to 20:1.

35. The process according to claim 31, further comprising introducing a second substance selected from the group consisting of washing actives, cleaning actives and mixtures thereof into the at least one cavity prior to applying the first film material over the opening of the at least one cavity.

36. The process according to claim 31, wherein the substance comprises an active present in a form selected from the group consisting of powders, granules, extrudates and combinations thereof, and wherein the active comprises a compound selected from the group consisting of builders, enzymes, bleaches, bleach activators, bleach catalysts, silver protectants, glass corrosion inhibitors and mixtures thereof.

37. The process according to claim 31, wherein the substance is free-flowing.

38. The process according to claim 31, wherein the substance comprises a liquid selected from the group consisting of nonionic surfactants, polymers, organic solvents, and mixtures thereof.

39. The process according to claim 31, wherein the first film material is water-soluble or water-dispersible.

40. The process according to claim 31, wherein thermoforming the first film material comprises generating a reduced pressure in the at least one cavity.

41. The process according to claim 40, wherein generating a reduced pressure in the at least one cavity comprises applying reduced pressure to a portion of the surface of the molding which is not covered by the first film material.

42. The process according to claim 40, wherein generating a reduced pressure in the at least one cavity comprises applying reduced pressure to a second opening on the surface of the molding, wherein the second opening connects the at least one cavity with a portion of the surface of the molding which is not covered by the first film material.

43. The process according to claim 31, wherein the first film material is adhesively bonded to the molding.

44. The process according to claim 31, further comprising sealing the opening after the substance is introduced into the at least one cavity.

45. The process according to claim 35, further comprising sealing the opening after the substance is introduced into the at least one cavity.

46. The process according to claim 44, wherein sealing the opening comprises applying a second film material over the opening and subjecting the second film material to a treatment selected from the group consisting of heat-sealing, ultrasound-sealing, high-frequency-sealing or a combination thereof.

47. The process according to claim 31, further comprising cutting the first film material in a circuit on the surface of the molding around the opening.

48. A process for producing a dosage unit for detergent or cleaning compositions, comprising:
(a) providing a ring tablet having a first surface opposing a second surface and an aperture extending through the ring tablet from a first opening on the first surface to a second opening on the second surface;
(b) introducing a mold into the first opening to a position within the aperture between the first opening and the second opening;
(c) applying a first film material over the second opening;
(d) thermoforming the first film material into the aperture to form a receiving chamber in the first film material in a portion of the aperture; and
(e) introducing a substance selected from the group consisting of washing actives, cleaning actives and mixtures thereof into the receiving chamber.

49. The process according to claim 48, further comprising sealing the second opening after the substance is introduced into the receiving chamber.

50. The process according to claim 49, further comprising removing the mold and introducing a second substance selected from the group consisting of washing actives, cleaning actives and mixtures thereof into the first opening.

51. The process according to claim 50, further comprising sealing the first opening after the second substance is introduced.

52. A dosage unit for washing/cleaning compositions comprising a molding having at least one cavity, a first film material thermoformed into the at least one cavity to form a receiving chamber, and a substance selected from the group consisting of washing actives, cleaning actives and mixtures thereof disposed in the receiving chamber within the at least one cavity.

53. The dosage unit according to claim 52, wherein the molding comprises a form selected from the group consisting of tablets, compactates, extrudates, injection moldings, castings, and combinations thereof.

54. The dosage unit according to claim 52, wherein the substance comprises an active selected from the group consisting of builders, enzymes, bleaches, bleach activators, bleach catalysts, silver protectants, glass corrosion inhibitors and mixtures thereof.

55. The dosage unit according to claim 52, further comprising a second substance selected from the group consisting of washing actives, cleaning actives and mixtures thereof, wherein the second substance is disposed in a portion of the at least one cavity not occupied by the receiving chamber.

56. The dosage unit according to claim 52, wherein the substance comprises a liquid selected from the group consisting of nonionic surfactants, polymers, organic solvents, and mixtures thereof.

57. The dosage unit according to claim 52, wherein the receiving chamber containing the substance is sealed with a second film material.

58. The dosage unit according to claim 52, wherein the first film material is adhesively bonded to the molding.

59. The dosage unit according to claim 57, wherein one or both of the first film material and the second film material is adhesively bonded to the molding.
